(19) United States
(12) Patent Application Publication
(10) Pub. No.: US 2024/0182683 A1
(43) Pub. Date: Jun. 6, 2024

(54) STABILIZER COMPOSITION, USE OF THE STABILIZER COMPOSITION, METHOD FOR STABILIZING CONDENSATION POLYMERS AGAINST HYDROLYTIC DEGRADATION, AND HYDROLYSIS-STABILIZED COMPOSITION AND MOLDING OR MOLDED PART CONSISTING THEREOF

(71) Applicant: FRAUNHOFER-GESELLSCHAFT ZUR FÖRDERUNG DER ANGEWANDTEN FORSCHUNG E.V., München (DE)

(72) Inventors: Jannik HALLSTEIN, Darmstadt (DE); Elke METZSCH-ZILLIGEN, Darmstadt (DE); Rudolf PFAENDNER, Darmstadt (DE)

(73) Assignee: FRAUNHOFER-GESELLSCHAFT ZUR FÖRDERUNG DER ANGEWANDTEN FORSCHUNG E.V., München (DE)

(21) Appl. No.: 18/549,802

(22) PCT Filed: Mar. 17, 2022
(86) PCT No.: PCT/EP2022/057056

§ 371 Date: Sep. 8, 2023

(30) Foreign Application Priority Data
Mar. 17, 2021 (DE) 10 2021 202 598.6

(51) Int. Cl. C08K 5/3412; C08K 3/26; C08K 3/34

(52) U.S. Cl. CPC C08K 5/3412; C08K 3/26; C08K 3/34; C08K 2003/343

(57) ABSTRACT

The present invention relates to a new stabilizer composition on the basis of an aziridine and at least a hydrotalcite, zeolite, dawsonite or mixtures thereof. The stabilizer composition is suitable for stabilizing condensation polymers, in particular aliphatic polyesters against hydrolytic degradation. The invention also relates to the use of the stabilizer composition according to the invention and to a method for stabilizing condensation polymers against hydrolytic degradation. The present invention further relates to molded parts and moldings that can be produced from the composition according to the invention.

The present invention relates to a novel stabilizer composition based on an aziridine and at least one hydrotalcite, zeolite, dawsonite or mixtures thereof. The stabilizer composition is suitable for stabilizing condensation polymers, especially aliphatic polyesters, against hydrolytic degradation. The invention also relates to the use of the stabilizer composition according to the invention and to a process for stabilizing condensation polymers against hydrolytic degradation. Furthermore, the present invention relates to moulded parts and moulded bodies which are producible from the composition according to the invention.

Polycondensation polymers such as polyesters, polyamides and polycarbonates are basically to be classified as hydrolysis-sensitive polymers, since the chemical bonds of these polymers may be cleaved by water. This may be advantageous for the degradation of these polymers, for example in the environment, but is also often a disadvantage, especially for technical applications and desired extended service lives. Increasingly, polymers from fossil raw materials are being replaced by polymers from renewable raw materials. These “bio” polymers are, for example, based on aliphatic polyesters such as polylactic acid, also known as polylactide or PLA. However, aliphatic ester groups are clearly more sensitive to hydrolysis than (partially) aromatic ester groups (see for example M. Dröscher et al, Angewandte Makromolekulare Chemie (“Applied Macromolecular Chemistry”) 1984, 128, 203-213).

Improving the hydrolysis stability of polycondensation polymers and PLA is a well-known issue. For example, WO 2012 072 489 mentions carbodiimides, polycarbodiimides, epoxides, alkylketene dimers and oxazolidinones as hydrolysis stabilizers. CN 101 759 969 describes hydrolysis-resistant PLA-based compositions comprising carbodiimides, epoxy, oxoazolines, oxazines or aziridines. Compositions are also known, for example from WO 94/24201, which, in addition to the hydrolysis stabilizer in the form of epoxides, comprise further additives such as calcium oxide or calcium silicates. The use of aziridines in polyesters and PLA is further mentioned for example in U.S. Pat. No. 3,959,228, in TW 1472575 or in US 2014/0100318. However, certain additives such as fillers may also negatively influence the hydrolysis resistance, for example it is known that layered silicates such as montmorillonites accelerate the hydrolysis of PLA (A. Rapacz-Kmita et al. Materials Letters 2015, 146, 73-76, Q. Zhao et al. Polymer Degradation and Stability 2008, 93, 1450-1459).

In addition, drilling fluids are known that may comprise aziridines, hydrotalcites and degradable polymers (WO2015/065575).

The closest prior art is therefore constituted by polycondensates comprising aziridines. For example, the use of aziridines in polyesters and PLA is mentioned in U.S. Pat. No. 3,959,228, in TW 1472575, in US 2014/0100318 or US 2016/024297.

There is thus a need to increase the hydrolysis stability of polycondensation polymers, particularly of polyesters and especially of aliphatic polyesters such as PLA, in order to expand the possible applications of these polymers.

This object is achieved with regard to a stabilizer composition having the features of claim 1. Claim 9 discloses possible uses of the stabilizer composition, while claim 10 relates to a method for stabilizing condensation polymers against hydrolytic degradation. Claim 13 relates to a hydrolysis-stabilized composition, claim 17 to a moulded part or a moulded article producible from the hydrolysis-stabilized composition.

The dependent claims each concern advantageous developments.

According to a first aspect, the present invention thus relates to a stabilizer composition consisting of at least one aziridine and at least one hydrotalcite, zeolite, dawsonite or mixtures thereof.

It is considered surprising that polyesters with combinations of aziridines with hydrotalcites, zeolites or dawsonites show particularly good hydrolysis stability. These combinations have not yet been described in the literature.

New hydrolysis-stabilized plastic compositions of polycondensation polymers such as polyesters or polyamides, as well as new stabilizer compositions for improving hydrolysis stability with high efficacy, especially for biopolymers such as PLA, are provided.

According to a preferred embodiment, the at least one aziridine is selected from the group consisting of monofunctional, difunctional, tetrafunctional and/or multifunctional aziridines having, for example, the following structures:

A) monofunctional aziridines
1-aziridinecarboxamide, N-octadecyl-;
1-aziridinecarboxamide, N-phenyl-;
1-aziridinecarboxamide, N-cyclohexyl-;
1-aziridinecarboxamide, N-1-naphthalenyl-;
1-aziridinecarboxamide, N-decyl-;
N-benzyloxycarbonylaziridine;
(4-methoxyphenyl)(2-methyl-1-aziridinyl)methanone;
N-(4-cyclohexylphenyl)-1-aziridinecarboxamide;
2-[2-(1-aziridinyl)ethoxy]-4-pyridinepyridinecarboxylic acid;
6-[2-(1-aziridinyl)ethoxy]-3-pyridinemethanamine;
6-[2-(1-aziridinyl)ethoxy]-2-pyridinepyridinecarboxylic acid;
2-[2-(1-aziridinyl)ethoxy]pyridine;
2-[2-(1-aziridinyl)ethoxy]-4-pyridinemethanamine;
2-methyl-aziridine;
2-[1-(1-aziridinylmethyl)propoxy]-pyridine;

B) difunctional aziridines
N,N′-hexamethylene-1,6-bis(1-aziridinecarboxamide);
N,N′-(methylenedi-p-phenylene)bis(aziridine-1-carboxamide);
N,N′-(methylenedi-4,1-phenylene)bis[2-methyl-1-aziridinecarboxamide];
1-aziridinecarboxamide, N,N′-(3,3′-dimethyl[1,1′-biphenyl]-4,4′-diyl)bis-;
1-aziridinecarboxamide, N,N′-[1,1′-biphenyl]-4,4′-diylbis-;
1-aziridinecarboxamide, N,N′-(methylenedi-4,1-phenylene)bis-;
1-aziridinecarboxamide, N,N′-(4-methyl-1,3-phenylene)bis-;
1-aziridinecarboxamide, N,N′-(1,4-phenylenedi-2,1-ethanediyl)bis-;
1-aziridinecarboxamide, N,N′-1,4-phenylenebis-;
N,N′-(hexane-1,6-diyl)bis(2-methylaziridine-1-carboxamide);
N,N′-1,2-ethanediylbis[1-aziridinecarboxamide];
N,N′-1,3-propanediylbis[1-aziridinecarboxamide];
N,N′-1,4-butanediylbis[1-aziridinecarboxamide];
N,N′-1,5-pentanediylbis[1-aziridinecarboxamide];
N,N′-1,6-hexanediylbis[1-aziridinecarboxamide];
N,N′-1,7-heptanediylbis[1-aziridinecarboxamide];
N,N′-1,8-octanediylbis[1-aziridinecarboxamide];
N,N′-1,9-nonanediylbis[1-aziridinecarboxamide];
N,N′-1,10-decanediylbis[1-aziridinecarboxamide];
1-aziridinecarboxamide, N,N′-(3-hydroxy-1,5-pentanediyl)bis-
1-aziridinecarboxamide, N,N′-1,5-naphthalenediylbis-;
1-aziridinecarboxamide, N,N′-(3,3′-dimethoxy[1,1′-biphenyl]-4,4′-diyl)bis-; pentane
1-aziridinecarboxamide, N,N′-(methyl-1,3-phenylene)bis-;
1-aziridinecarboxamide, N,N′-[1,1′-biphenyl]-4,4′-diylbis-;
poly(oxy-1,4-butanediyl),α-[[[3-[(1-aziridinylcarbonyl)amino]-4-methylphenyl]amino]carbonyl]-ω-[[[[3-[(1-aziridinylcarbonyl)amino]-4-methylphenyl]amino]carbonyl]oxy]-;
N,N″-(methylenedi-4,1-phenylene)bis[N′-1-aziridinyl urea;

c) trifunctional aziridines
pentaerythritol tris[3-(1-aziridinyl)propionate];
trimethylolpropane tris[3-(2-methylaziridin-1-yl)propionate];
trimethylolpropane tris[3-(aziridin-1-yl)propionate];
1-aziridine propionic acid, 2-[[3-(1-aziridinyl)-1-oxopropoxy]methyl]-1,3-propanediyl ester;
1-aziridine propionic acid, α-methyl, 1,1′-[2-[[3-(1-aziridinyl)-2-methyl-1-oxopropoxy]methyl]-2-ethyl-1,3-propanediyl]ester;
1-aziridine propionic acid, 2-[[(1-aziridinylacetyl)oxy]methyl]-2-ethyl-1,3-propanediyl ester;
1-aziridine propionic acid, 2-methyl-, 1,1′,1″-(2-ethyl-1,2,3-propanetriyl) ester;
1-aziridinecarboxamide, N,N′,N″-(methylidynetri-4,1-phenylene)tris;
1-aziridinecarboxamide, N,N′-[[[6-[(1-aziridinylcarbonyl)amino]hexyl]imino]bis(carbonylimino-6,1-hexanediyl)]bis-;
1-aziridine propionic acid, 2-methyl, 1,1′-[2-ethyl-2-[[3-(2-methyl-1-aziridinyl)-1-oxopropoxy]methyl]-1,3-propanediyl]ester;
1-aziridine propionic acid, 1,1′-[2-[[3-(1-aziridinyl)-1-oxopropoxy]methyl]-2-ethyl-1,3-propanediyl]ester;
1-aziridine propionic acid, 1,1′-[2-[[3-(1-aziridinyl)-1-oxopropoxy]methyl]-2-(hydroxymethyl)-1,3-propanediyl]ester;
poly(oxy-1,2-ethanediyl), α,α′,α″-1,2,3-propanetriyltris[ω-[[[[3-[(1-aziridinylcarbonyl)amino]-4-methylphenyl]amino]carbonyl]oxy]-; aziridines, 1,1′,1″-(s-phenenyltricarbonyl)tris[2-methyl-;

D) tetrafunctional aziridines
pentaerythritol tetrakis(β-aziridino)propionate;
1-aziridine propionic acid, 1,1′-[2,2-bis[[3-(1-aziridinyl)-1-oxopropoxy]methyl]-1,3-propanediyl]ester;
1-aziridine propionic acid, 2-methyl, 1,1′-[2,2-bis[[3-(2-methyl-1-aziridinyl)-1-oxopropoxy]methyl]-1,3-propanediyl]ester;
1-aziridine ethanol, α,α′-[[2,2-bis[2-hydroxy-3-(2-methyl-1-aziridinyl)propoxy]methyl]-1,3-propanediyl]bis(oxymethylene)]bis[2-methyl-;
ethanone, 2,2′,2″,2′″-[[2,2′-bipyridine]-6,6′-diylbis(methylenenitrilo)]tetrakis[1-(2-methyl-1-aziridinyl)-;
1,5-pentandion, 2-[bis[2-(2-methyl-1-aziridinyl)-2-oxoethyl]amino]-1,5-bis(2-methyl-1-aziridinyl)-;
ethanone, 2,2′,2″,2′″-(1,2-ethanediyldinitrilo)tetrakis[1-(2-methyl-1-aziridinyl)-;
methanone, 1,1′,1″,1′″-(1,4,5,8-naphthalenetetrayl)tetrakis[1-(2-methyl-1-aziridinyl)-;
1-aziridine ethanol, α,α′-[[2,2-bis[2-hydroxy-3-(2-methyl-1-aziridinyl)propoxy]methyl]-1,3-propanediyl]bis(oxymethylene)]bis[2-methyl-;

E) multifunctional aziridines
1-aziridine propionic acid, 1,1′-[2-[[3-[3-(1-aziridinyl)-1-oxopropoxy]-2,2-bis[[3-(1-aziridinyl)-1-oxopropoxy]methyl]propoxy]methyl]- 2-[[3-(1-aziridinyl)-1-oxopropoxy]methyl]-1,3-propandiyl]ester;
1-aziridine propionic acid, 2-methyl-, 1,1′-[2-[[3-[3-(1-aziridinyl)-1-oxopropoxy]-2-(hydroxymethyl)-2-[[3-(2-methyl-1- aziridinyl)-1-oxopropoxy]methyl]propoxy]methyl]-2-[[3-(2-methyl-1-aziridinyl)-1-oxopropoxy]methyl]-1,3-propandiyl]ester;
1-aziridine propionic acid, β,2-dimethyl, benzylhexaylhexamethylene ester;
1-aziridine propionic acid, 2-ethyl-β-methyl, benzylhexaylhexakis(methylene)ester; as well as mixtures and combinations of the aziridines mentioned above.

Particularly suitable aziridines here are:

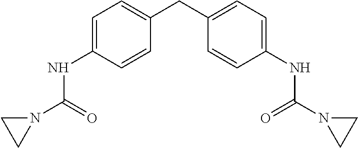 [SMILES: O=C(Nc1ccc(Cc2ccc(NC(=O)N3CC3)cc2)cc1)N1CC1]

N,N′-(methylenedi-p-phenylene)bis(aziridine-1-carboxamide),

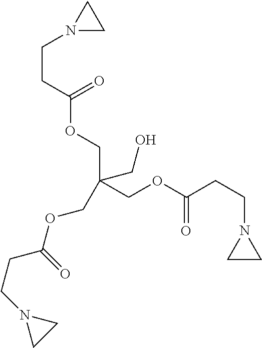 [SMILES: O=C(CCN1CC1)OCC(CO)(COC(=O)CCN1CC1)COC(=O)CCN1CC1]

pentaerythritol tris[3-(1-aziridinyl)propionate]

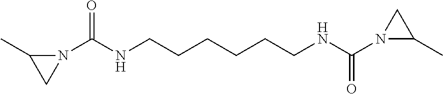

N,N′-(hexane-1,6-diyl)bis(2-methylaziridine-1-carboxamide)

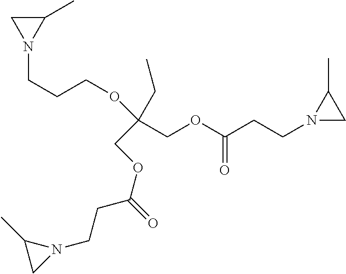 [SMILES: CCC(COC(=O)CCN1CC1C)(COC(=O)CCN1CC1C)OCCCN1CC1C]

trimethylolpropane tris[3-(2-methylaziridin-1-yl)propionate]

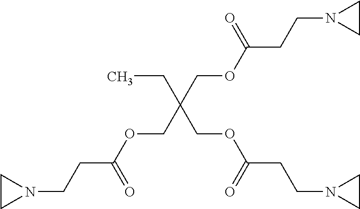 [SMILES: CCC(COC(=O)CCN1CC1)(COC(=O)CCN1CC1)COC(=O)CCN1CC1]

trimethylolpropane tris[3-(aziridin-1-yl)propionate]

Other preferred aziridines are described in WO 2020/020714 and in WO 2021/148570. The disclosure content of these patent applications in relation to the aziridines mentioned is made part of the disclosure content of the present invention.

Particularly preferred aziridines are the following compounds:

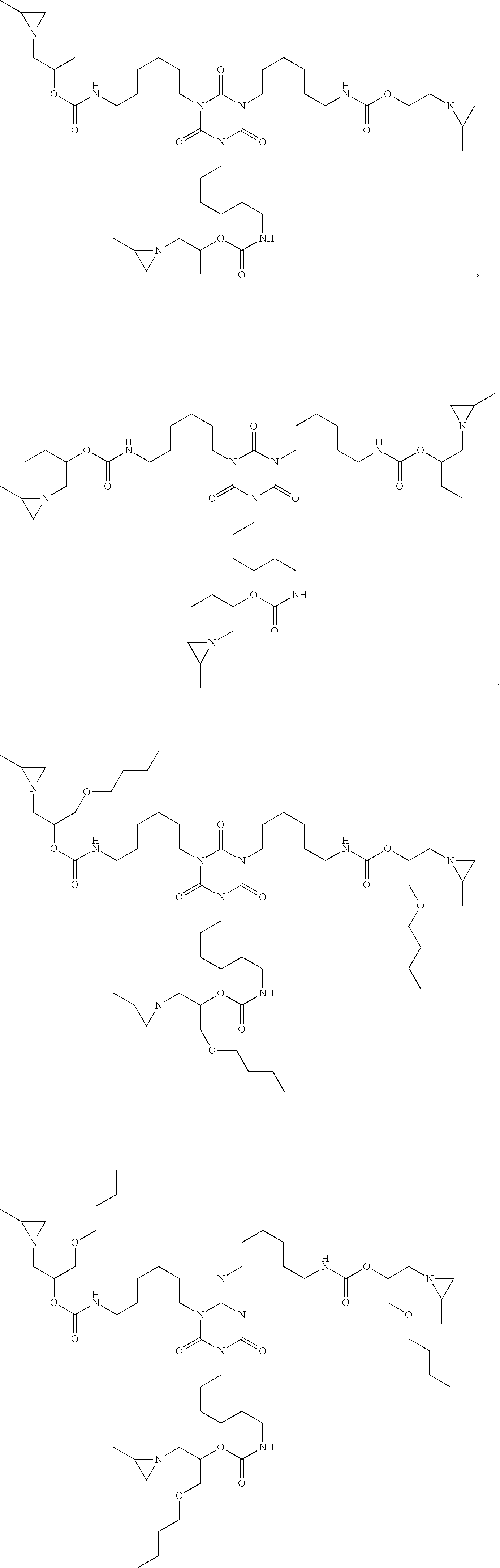

Some of the aziridines mentioned are commercially available, for example from the company Menadiona (Barcelona, Spain) or Polyaziridine LLC (Palm Beach, USA).

Preferably, the at least one hydrotalcite is selected from the group consisting of compounds of the general formula

(M²⁺)₁₋ₓ·(M³⁺)ₓ·(OH)₂·(Aⁿ⁻)_{x/n}·m H₂O

where
M²⁺ one or more of the metals from the group Mg, Ca, Sr or Zn,
M³⁺ Al or B,
A an anion with valency n, preferably OH⁻, HCO₃⁻, CH₃COO⁻, C₆H₅COO⁻, CO₃²⁻, SO₄²⁻, HPO₄²⁻,
n 1 or 2,
0<x<0.5, and
m a number from 0 to 20.

In particular, the hydrotalcites are selected from the group consisting of Ca₄Al₂(OH)₁₂CO₃·5H₂O, Al₂O₃·6MgO·CO₂·12H₂O, Mg_{4,5}Al₂(OH)₁₃·CO₃·3.5H₂O, Mg₆Al₂(OH)₁₆·CO₃·4H₂O, 4MgO·AlO₃·CO₂·9H₂O, 4 MgO·Al₂O₃·CO₂·6H₂O, ZnO·3 MgO·Al₂O₃·CO₂·8-9H₂O and ZnO·3MgO·Al₂O₃·CO₂·5-6H₂O.

It is further advantageous if the at least one dawsonite is selected from the group consisting of compounds of the general formula

{(M₂O)ₘ·(Al₂O₃)·Zₒ·p H₂O}

where
M an element selected from the group consisting of H, Li, Na, K, Mg_{1/2}, Ca_{1/2}, Sr_{1/2}, Zn_{1/2};
Z a substituent selected from the group consisting of CO₂, SO₂, (Cl₂O₇)_{1/2}, B₄O₆, S₂O₂ (thiosulphate) and/or C₂O₂ (oxalate);
m , if M is Mg_{1/2}, Ca_{1/2}, a number between 1 and 2, in all other cases a number between 1 and 3;
n a number between 1 and 4;
o a number between 2 and 4; and
p a number between 0 and 30.

In particular, the at least one dawsonite is selected from the group consisting of potassium aluminocarbonate {(K₂₀)·(Al₂O₃)·(CO₂)₂·2H₂O}, sodium aluminothiosulphate {(Na₂₀)·(Al₂O₃)·(S₂O₂)₂·2H₂O}, potassium aluminosulphite {(K₂₀)·(Al₂O₃)·(SO₂)₂·2H₂O}, calcium aluminooxalate {(CaO)·(Al₂O₃)·(C₂O₂)₂·5H₂O}, magnesium aluminotetraborate {(MgO)·(Al₂O₃)·(B₄O₆)₂·5H₂O}, sodium aluminodihydroxycarbonate, potassium aluminodihydroxycarbonate and naturally occurring alkali aluminocarbonate minerals such as indigirite, tunisite, aluminohydrocalcite and strontiodresserite.

Preferably, the at least one zeolite is selected from the group consisting of compounds of the general formula

M_{x/n}[(AlO₂]ₓ(SiO₂)_{y}·w H2O

where
n the charge of the cation M;
M an element of the first or second main group, especially Li, Na, K, Mg, Ca, Sr or Ba;
y:x a value from 0.8 to 15, preferably from 0.8 to 1.2, and
w a number from 0 to 300, preferably from 0.5 to 5.

In particular, the at least one zeolite is selected from the group consisting of sodium aluminosilicates of the formulae Na₁₂Al₁₂Si₁₂O₄₈·27H₂O [zeolite A], Na₆Al₆Si₅O₂₄·2NaX·7,5H₂O (X=OH, halogen, ClO₄ [sodalite]); Na₆Al₆Si₃₀O₇₂·24H₂O; Na₈Al₈Si₄₀O₉₅·24H₂O; Na₁₆Al₁₆Si₂₄O₈₀·16H₂O; Na₁₆Al₁₆Si₃₂O₉₆·16H₂O; Na₅₆Al₅₆Si₁₃₆O₃₈₄·250H₂O [zeolite Y], Na₈₆Al₈₆Si₁₀₆O₃₈₄·264H₂O [zeolite X]; K₉Al₉Si₂₇O₇₂·22H₂O [zeolite L]; and zeolites in which the Na atoms of the aforementioned zeolites are partially or completely replaced by Li, K, Mg, Ca, Sr or Zn atoms, such as in particular (Na,K)₁₀Al₁₀Si₂₂O₆₄·20H₂O, Ca_{4,5}Na₃[(AlO₂)₁₂(SiO₂)₁₂·30H₂O and K₉Na₃[(AlO₂)₁₂SiO₂)₁₂]·27H₂O.

In particular, it is advantageous if the hydrotalcites, zeolites, dawsonites or mixtures thereof are used as an anhydrous formulation.

In the stabilizer composition according to the present invention, it is further advantageous if the weight ratio of the totality of the aziridine to the totality of the at least one hydrotalcite, dawsonite and/or zeolite is from 20:1 to 1:20, preferably from 10:1 to 1:10, more preferably from 5:1 to 1:5.

In addition, the present invention relates to the use of a stabilizer composition according to the invention, described above, for stabilizing condensation polymers against hydrolytic degradation.

In another aspect, the present invention relates to a method for stabilizing condensation polymers against hydrolytic degradation, in which a stabilizer composition according to the invention and described in the foregoing is admixed or blended with the condensation polymer.

Both the use according to the invention and the method according to the invention are advantageously distinguished in that the stabilizer composition is used or admixed in a weight ratio of from 0.01 to 10% by weight, preferably from 0.05 to 5% by weight, more preferably from 0.1 to 3% by weight, in relation to the polycondensation polymer.

In addition, the present invention relates to a hydrolysis-stabilized composition comprising or consisting of at least one condensation polymer as well as a stabilizer composition according to the invention according to any one of claims 1 to 8.

In a preferred embodiment of the use, method or composition, it is provided that the condensation polymer is selected from the group consisting of
a) polyamides, such as for example polyamide 6, 6.6, 6.9, 6.10, 4.6, 4.10, 6.12, 10.10, 10.12, 12.12, polyamide 4, polyamide 7, polyamide 8, polyamide 9, polyamide 11, polyamide 12 as well as (partially) aromatic polyamides, such as for example polyphthalamides, for example produced from terephthalic acid and/or isophthalic acid, and aliphatic diamines, such as for example hexamethylenediamine or m-xylylenediamine, or from aliphatic dicarboxylic acids, such as for example adipic acid or sebacic acid, and aromatic diamines, such as for example 1,4- or 1,3-diaminobenzene, designated for example as polyamide 6T, polyamide 9T, polyamide 6I, polyamide 6-3-T, blends of different polyamides, such as for example PA 6 and PA 6.6, PA 6T and PA 6I, PA 6.6 and PA 6T, or blends of polyamides and polyolefins, such as for example PA/PP or PA/PE.
b) Polyesters of aliphatic or aromatic dicarboxylic acids and diols or of hydroxy-carboxylic acids, in particular aliphatic polyesters, such as for example polyethylene terephthalate (PET), polybutylene terephthalate (PBT), polytrimethylene terephthalate (PTT), polypropylene terephthalate (PPT), polyethylene naphthylate (PEN), poly-1,4-dimethylol cyclohexane terephthalate, polyhydroxybenzoate, polyhydroxynaphthalate, polylactic acid (PLA), polyhydroxybutyrate (PHB), polyhydroxyvalerate (PHV), polybutylene succinate (PBS), polybutylene succinate adipate (PBSA), polyethylene succinate, polycaprolactone,
c) polycarbonates, polyester carbonates, as well as blends such as PC/ABS, PC/PBT, PC/PET/PBT, PC/PA,
d) as well as mixtures, combinations or blends of two or more of the aforementioned polymers.

Furthermore, the polymers specified under a) to c) may have both amorphous and (partially) crystalline morphologies.

Particularly preferred polyesters are aliphatic polyesters, i.e. polyesters that may be produced from aliphatic dicarboxylic acids and aliphatic diols or from aliphatic lactones.

Suitable diols for aliphatic polyesters are, for example, ethylene glycol, 1,3-propanediol, 1,2-propanediol, 1,4-butanediol, neopentyl glycol, 1,5-pentanediol, 1,6-hexanediol, 2,5-hexanediol, 3-methyl-2,4-pentanediol, 2-methyl-2,4-pentanediol, 2,2,4-trimethyl-1,3-pentanediol, 1,8-octanediol, 1,10-decanediol, 1,12-dodecanediol, -1,6,2-ethylhexanediol-1,3, 2,2-diethylpropanediol-1,3, 2,2-bis-(4-hydroxycyclohexyl)-propane, 2,2-bis-(4-hydroxypropoxyphenyl)propane, 1,4-cyclohexanediol, 1,3-cyclohexanediol, 1,4-cyclohexanedimethanol, 1,3-cyclohexanedimethanol.

Suitable dicarboxylic acids are, for example, malonic acid, dimethylmalonic acid, succinic acid, glutaric acid, adipic acid, pimelic acid, suberic acid, azelaic acid, sebacic acid, dodecanedioic acid, brassylic acid, tetradecanedioic acid, hexadecanedioic acid, cyclohexane-1,3-dicarboxylic acid or cyclohexane-1,4-dicarboxylic acid.

In addition to aliphatic structures, aromatic structures may also be present to a subordinate extent of up to 20 mol. %, preferably less than 10 mol. %, very particularly preferably less than 1 mol. %. Suitable aromatic structures in the case of diols are hydroquinone, resorcinol, 2,6-naphthalene diol, 1,8-naphthalene diol, bisphenol-A, for dicarboxylic acids terephthalic acid, isophthalic acid, naphthalene-2,6-dicarboxylic acid; an example of a heterocyclic aromatic dicarboxylic acid is 2,5-furandicarboxylic acid.

Suitable hydroxycarboxylic acids are, for example, lactic acid, glycolic acid, 4-hydroxybutyric acid, 3-hydroxybutyric acid or 3-hydroxyvaleric acid; a hydroxycarboxylic acid with aromatic moieties is mandelic acid.

Other preferred polyesters are, in particular, polybutylene terephthalate (PBT) and copolymers of 1,4-butanediol with terephthalic acid, adipic acid or sebacic acid.

Preferred polyamides are, in particular, polyamide 6, polyamide 6.6, blends of polyamide 6 with polyamide 6.6, polyamide 10.10, polyamide 10.12, polyamide 12.12, polyamide 11 and polyamide 12.

In addition, the compositions may comprise other additives selected from the group consisting of secondary antioxidants, UV absorbers, light stabilizers, metal deactivators, filler deactivators, antiozonants, nucleating agents, antinucleating agents, impact modifiers, plasticizers, lubricants, rheology modifiers, thixotropic agents, chain extenders, processing aids, demoulding aids, flame retardants, pigments, dyes, optical brighteners, antimicrobial agents, antistatic agents, slip agents, antiblocking agents, coupling agents, crosslinking agents, anti-crosslinking agents, hydrophilizing agents, hydrophobicizing agents, hydrolysis stabilizers, adhesion promoters, dispersing agents, compatibilizers, oxygen scavengers, acid scavengers, blowing agents, degradation additives, defoaming agents, odour scavengers, marking agents, antifogging agents, fillers and reinforcing agents.

In a preferred embodiment, the compositions contain, in particular, phosphites or phosphonites, fillers or acid scavengers.

Suitable phenolic antioxidants are, for example:
alkylated monophenols, such as for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, linear or branched nonylphenole, such as for example 2,6-dinonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol, and mixtures thereof;
alkylthiomethylphenols, such as for example 2,4-dioctylthiomethyl-6-tert-butylphenol, 2,4-dioctylthiomethyl-6-methylphenol, 2,4-dioctylthiomethyl-6-ethylphenol, 2,6-didodecylthiomethyl-4-nonylphenol;
hydroquinones and alkylated hydroquinones, such as for example 2,6-di-tert-butyl-4-methyoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenylstearate, bis(3,5-di-tert-butyl-4-hydroxylphenyl)adipate;
tocopherols, such as for example α-, β-, γ-, δ-tocopherol and mixtures of these (vitamin E);
hydroxylated thiodiphenyl ethers, such as for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulphide;
alkylidene bisphenols, such as for example 2,2′methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol, 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethyleneglycol-bis[3,3-bis(3′-tert-butyl-4′-hydroxyphenyl)butyrate], bis(3-tert-butyl-4-hydroxy-5-methylphenyl)dicyclo-pentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra(5-tert-butyl-4-hydroxy-2-methylphenyl)pentane;
O-, N- and S-benzyl compounds, such as for example 3,5,3′,5′-tetra-tert-butyl-4,4′-dihydroxydibenzylether, octadecyl-4-hydroxy-3,5-dimethylbenzylmercaptoacetate, tridecyl-4-hydroxy-3,5-di-tert-butyl-benzyl-mercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulphide, isooctyl-3,5-di-tert-butyl-4-hydroxybenzylmercaptoacetate;
hydroxybenzylated malonates, such as for example dioctadecyl-2,2-bis(3,5-di-tert-butyl-2-hydroxybenzyl)malonate, dioctadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate;
aromatic hydroxybenzyl compounds, such as for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-cert-butyl-4-hydroxybenzyl)phenol;
triazine compounds, such as for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxphenylethyl)-1,3,5-triazine, 1,3,5-tris(3,5-di-tert-butyl-4-hydroyphenylpropionyl)hexahydro-1,3,5-triazine, 1,3,5-tris(3,5-dicyclohexyl-4-hydroxybenzyl)isocyanurate;
benzyl phosphonates, such as, dimethyl-2,5-di-tert-butyl-4-hydroxybenzylphosphonat, dietyhl-3,5-di-tert-butyl-4-hydroxybenzylphosphonat, dioctadecyl-3,5-di-tert-butyl-4-hydroxybenzylphosphonat, dioctadecyl-5-tert-butyl-4-hydroxy-3-methylbenzylphosphonate, the calcium salt of the monoethyl ester of 3,5-di-tert-butyl-4-hydroxybenzylphosphonic acid;
acylaminophenols, such as 4-hydroxylauranilide, 4-hydroxystearanilide, octyl N-(3,5-di-tert-butyl-4-hydroxyphenyl)carbamate;
esters of β-(3,5-di-tert-butyl-4-hydroxyphenyl)propionic acid with monohydric or polyhydric alcohols, for example methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;
esters of β(5-tert-butyl-4-hydroxy-3-methylphenyl)propionic acid with monohydric or polyhydric alcohols, for example methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane, 3,9-bis[2-{3-(3-tert-butyl-4-hydroxy-5-methylphenyl)propionyloxy}-1,1-dimethylethyl]-2,4,8,10-tetraoxaspiro[5.5]undecane;
esters of β-(3,5-dicyclohexyl-4-hydroxyphenyl)propionic acid with monohydric or polyhydric alcohols, for example methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;
esters of (3,5-di-tert-butyl-4-hydroxyphenyl)acetic acid with monohydric or polyhydric alcohols, for example methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;
amides of β-(3,5-di-tert-butyl-4-hydroxyphenyl)propionic acid such as for example N,N′-bis(3,5-di-tert-butyl-4-hydroxyphenylpropionyl)hexamethylenediamide, N,N′-bis(3,5-di-tert-butyl-4-hydroxyphenylpropionyl) hexamethylenediamide, N,N′-bis(3,5-di-tert-butyl-4-hydroxyphenylpropionyl)hexamethylenediamide, N,N′-bis(3,5-di-tert-butyl-4-hydroxyphenylpropionyl)hydrazide, N,N′-bis[2-(3-[3,5-di-tert-butyl-4-hydroxy-phenyl]propionyloxy)ethyl]oxamide (Naugard®XL-1, distributed by Uniroyal);
ascorbic acid (vitamin C).

Particularly preferred phenolic antioxidants are the following structures:

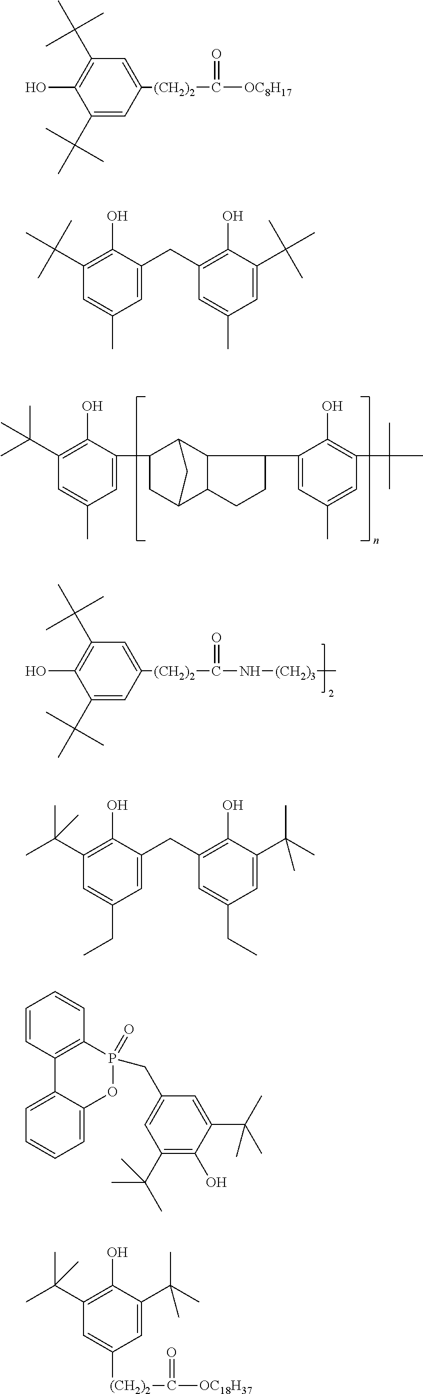

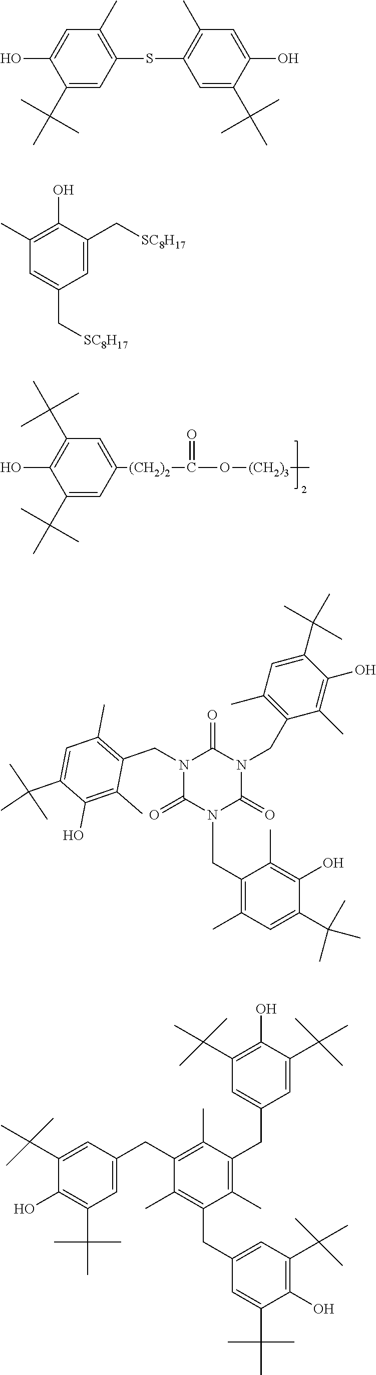

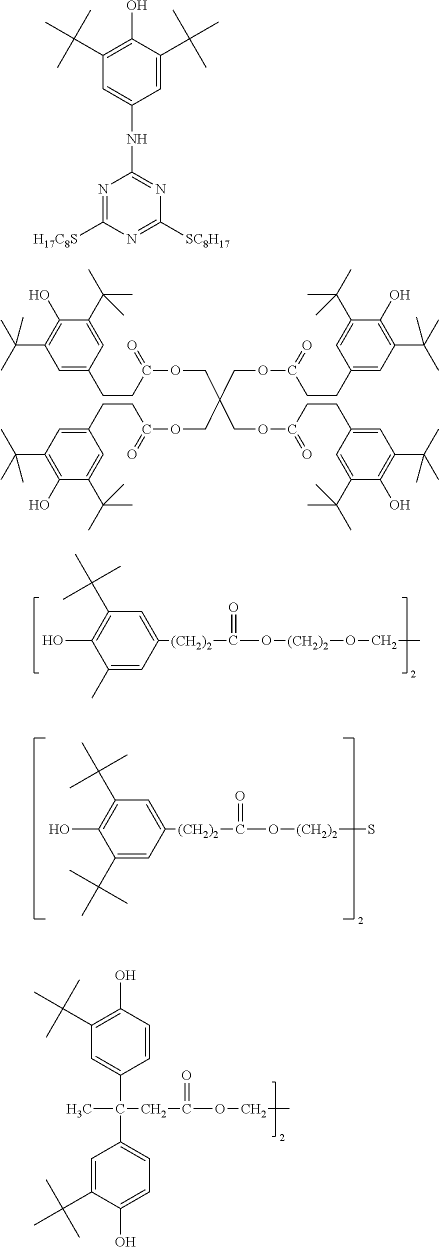

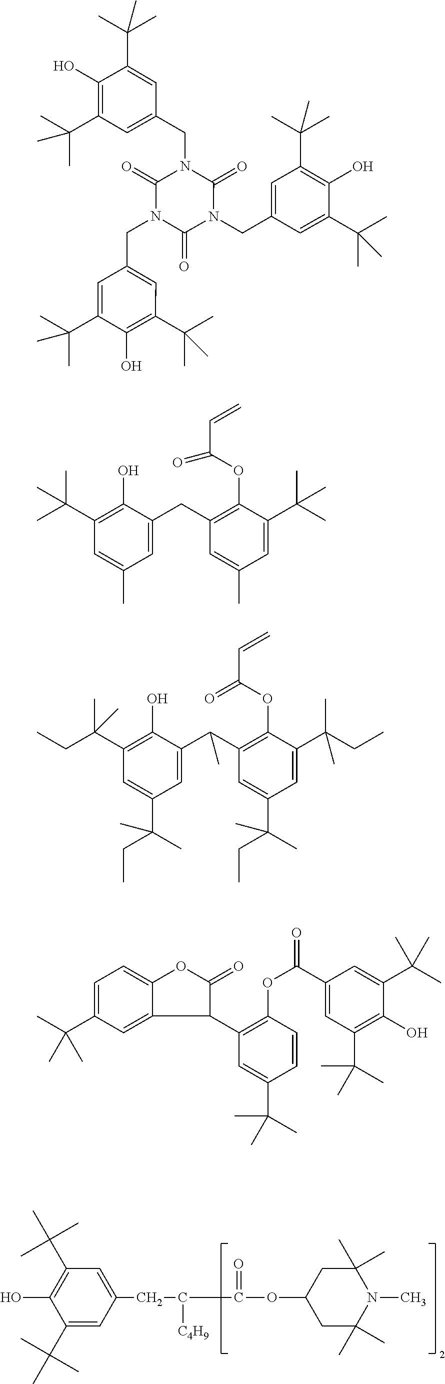

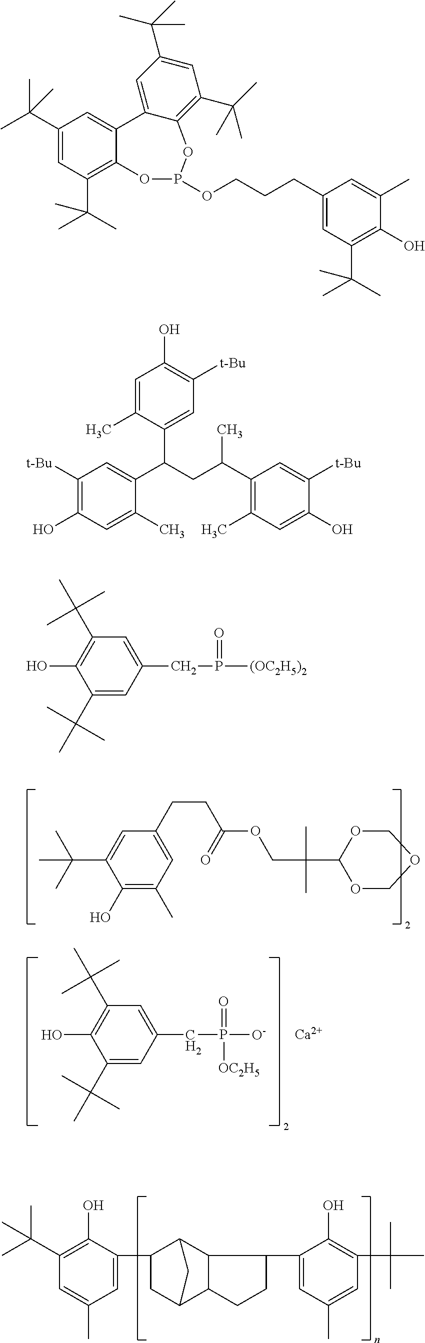

wherein in the previously mentioned compounds n is an integer and is between 2 and 10.

Other preferred phenolic antioxidants are phenolic antioxidants based on renewable raw materials, such as for example α-, β-, γ-, δ-tocopherol and mixtures thereof (vitamin E), tocotrienols, tocomonoenols, ubiquinol, hydroxytyrosol, flavonoids and flavonols, such as for example chrysin, quercitin, hesperidin, neohesperidin, naringin, morin, kaempferol, fisetin, datiscetin, luteolin, apigenin, taxifolin, isoflavones, such as for example genistein, genistin, daidzein, daidzin, formononetin, anthocyanins, such as for example delphinidin and malvidin, curcumin, carnosolic acid, carnosol, rosmarinic acid, tannin and resveratrol as well as carotenoids with alcoholic groups, such as for example beta-cryptoxanthin, lutein, zeaxanthin or astaxanthin.

Suitable aminic antioxidants are, for example:
N,N′-diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylamino-phenol, bis(4-methoxyphenyl)amine, 2,6-di-tert-butyl-4-dimethylaminomethyl-phenol, 2,4′-diaminodiphenylmethane, 4,4′-diaminodiphenylmethane, N,N,N′,N′-tetra-methyl-4,4′-diaminodiphenylmethane, 1,2-bis[(2-methyl-phenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyl-diphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octylphenothiazines, N-allylphenothiazine, N,N,N′,N′-tetraphenyl-1,4-diaminobut-2-ene, and mixtures or combinations thereof.

Preferred aminic antioxidants are: N,N′-diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine

Particularly preferred aminic antioxidants are the structures:

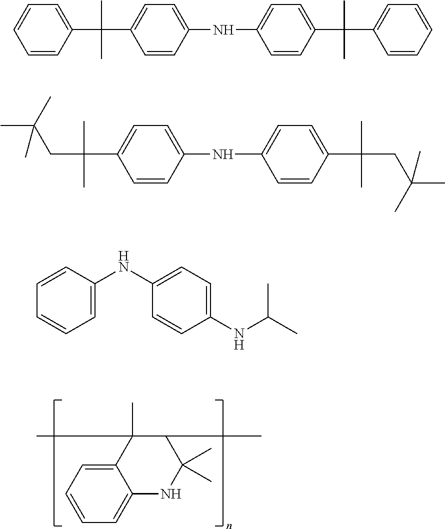

Preferred hydroxylamines or N-oxides (nitrones) are, for example, N,N-dialkylhydroxylamines, N,N-dibenzylhydroxylamine, N,N-dilaurylhydroxylamine, N,N-distearylhydroxylamine, N-benzyl-α-phenylnitrone, N-octadecyl-α-hexadecylnitrone, as well as Genox EP (SI Group) according to the formula:

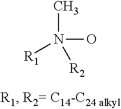

Suitable lactones are benzofuranones and indolinones such as for example 3-(4-(2-acetoxyethoxy)phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-(2-hydroxyethoxy]phenyl)benzofuran-2-one), 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, 3-(2,3-di methylphenyl)-5,7-di-tert-butyl-benzofuran-2-one, as well as lactones which additionally contain phosphite groups such as, for example.

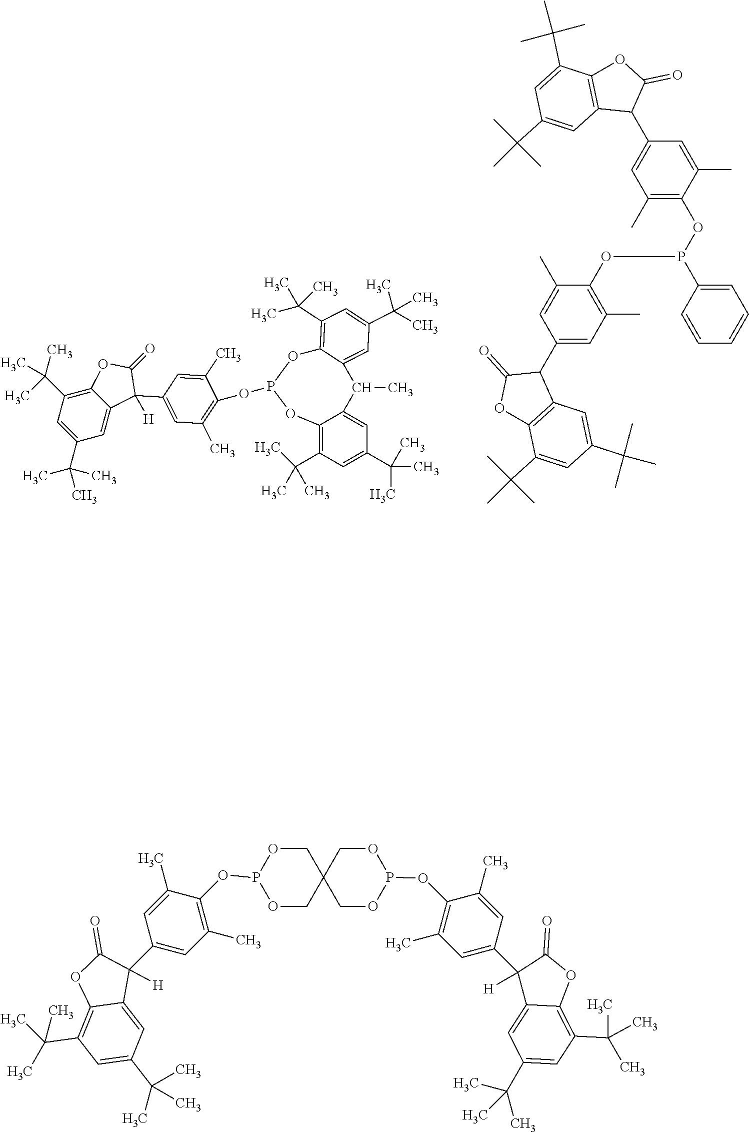 [SMILES: Cc1cc(C2C(=O)Oc3c2cc(C(C)(C)C)cc3C(C)(C)C)cc(C)c1OP1Oc2c(cc(C(C)(C)C)cc2C(C)(C)C)C(C)c2cc(C(C)(C)C)cc(C(C)(C)C)c2O1 ; Cc1cc(C2C(=O)Oc3c2cc(C(C)(C)C)cc3C(C)(C)C)cc(C)c1OP(Oc1c(C)cc(C2C(=O)Oc3c2cc(C(C)(C)C)cc3C(C)(C)C)cc1C)c1ccccc1 ; Cc1cc(C2C(=O)Oc3c2cc(C(C)(C)C)cc3C(C)(C)C)cc(C)c1OP1OCC2(CO1)COP(Oc1c(C)cc(C3C(=O)Oc4c3cc(C(C)(C)C)cc4C(C)(C)C)cc1C)OC2]

Preferred fillers are calcium carbonate, silicates, talc, mica, kaolin, metal oxides and metal hydroxides, carbon black, graphite, wood flour or fibres of natural products such as cellulose. Other suitable fillers are hydrotalcites or zeolites or layered silicates such as montmorillonite, bentonite, beidelite, mica, hectorite, saponite, vermiculite, ledikite, magadite, illite, kaolinite, wollastonite, attapulgite.

Suitable secondary antioxidants are, in particular, phosphites or phosphonites, such as for example
triphenylphosphite, diphenylalkylphosphites, phenyldialkylphosphites, tri(nonylphenyl)phosphite, trilaurylphosphites, trioctadecylphosphite, distearylpentaerythritol diphosphite, tris-(2,4-di-tert-butylphenyl)phosphite, diisodecylpentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritoldiphosphite, bis(2,4,6-tris(tert-butylphenyl)pentaerythritoldiphosphite, tristearylsorbitoltriphosphite, tetrakis(2,4-di-tert-butylphenyl)-4,4′-biphenylendiphosphonite, 6-isooctyloxy-2,4,8,10-tetra-tert-butyl-12H-dibenz[d,g]-1,3,2-dioxaphosphocine, bis(2,4-di-tert-butyl-6-methylphenyl)methylphosphite, bis(2,4-di-tert-butyl-6-methylphenyl)ethylphosphite, 6-fluoro-2,4,8,10-tetra-tert-butyl-12-methyl-dibenz[d,g]-1,3,2-dioxaphosphocine, 2,2′2″-nitrilo[triethyltris(3,3″,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl))phosphite, 5-butyl-5-ethyl-2-(2,4,6-tri-tert-butylphenoxy)-1,3,2-dioxaphosphirane.

Particularly preferred phosphites are:

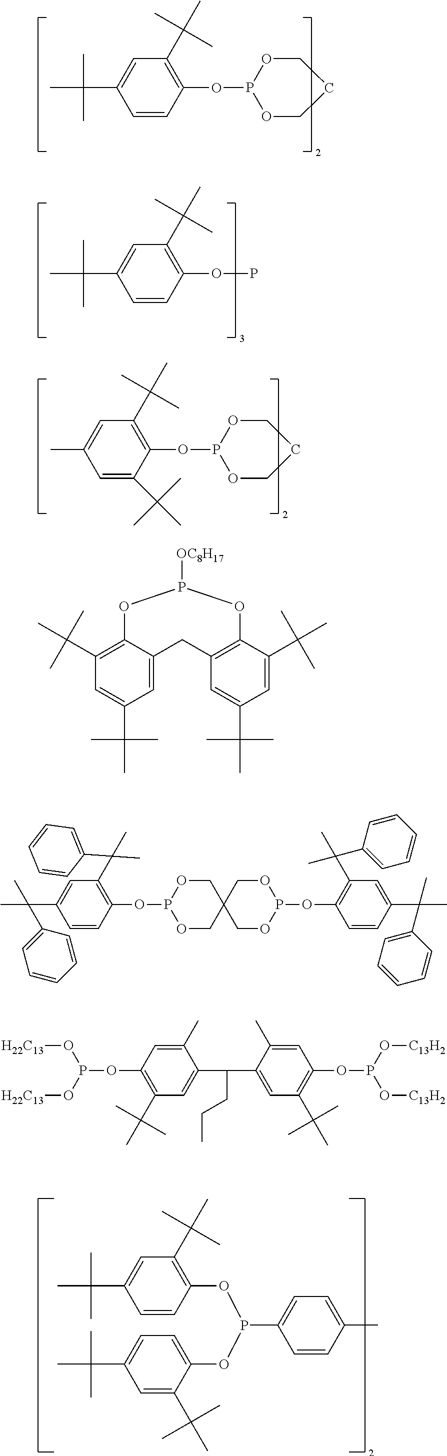

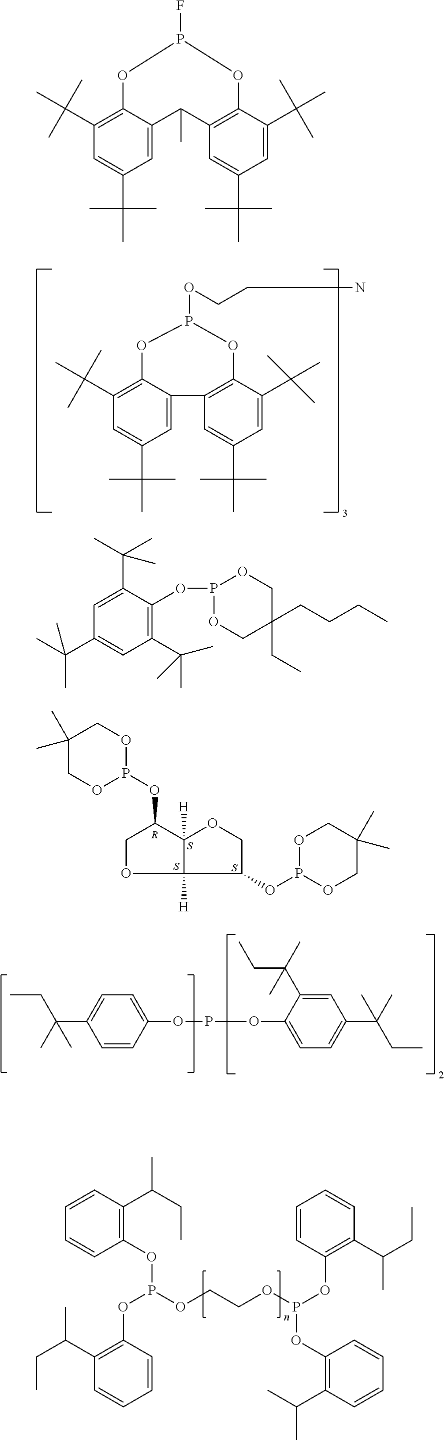

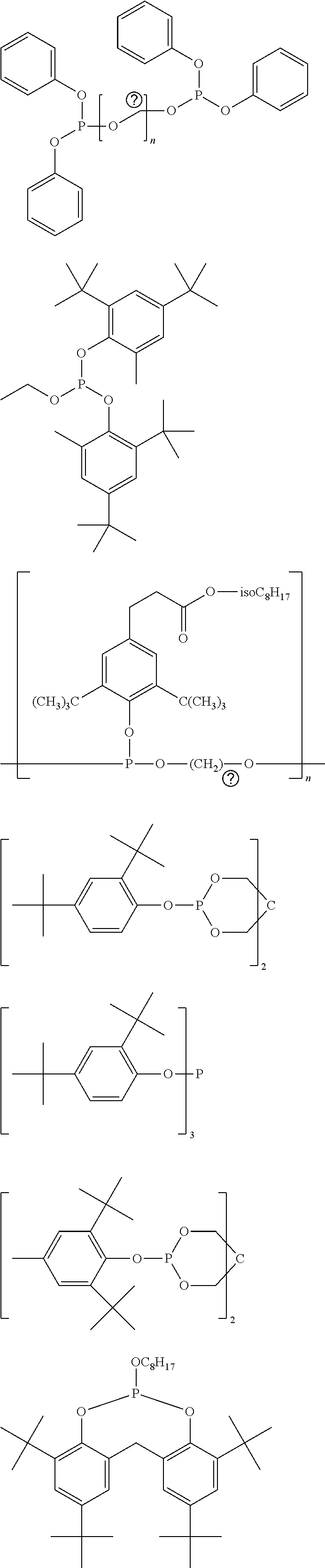

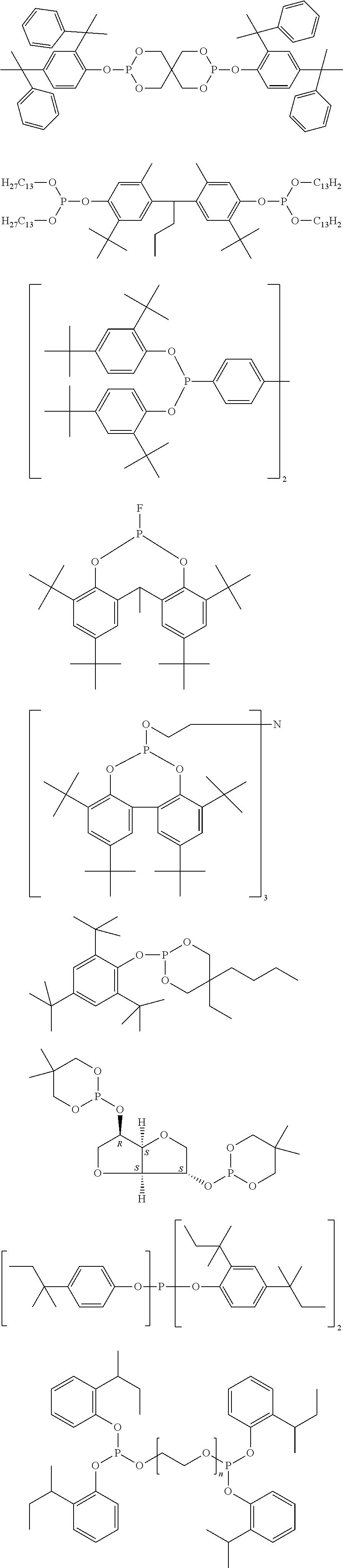

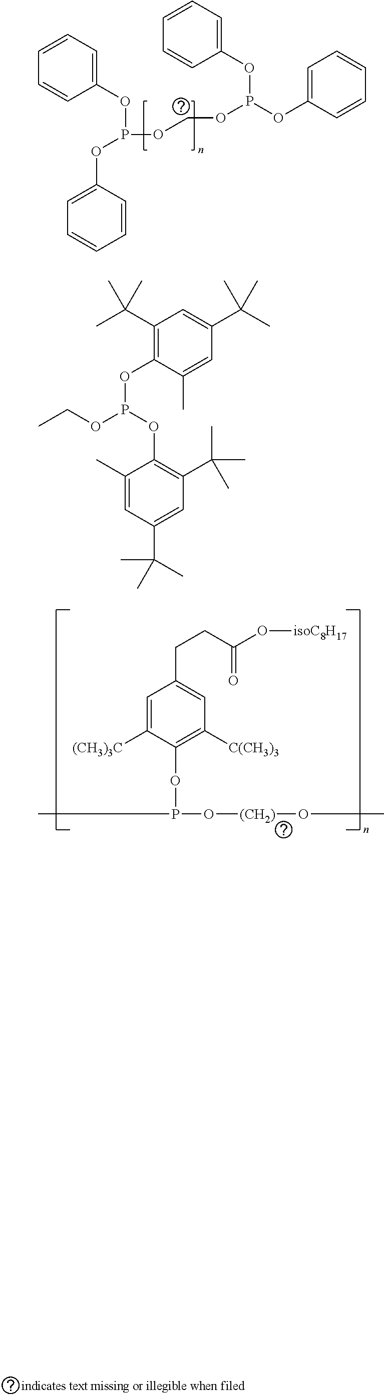

with n=3-100

A preferred phosphonite is:

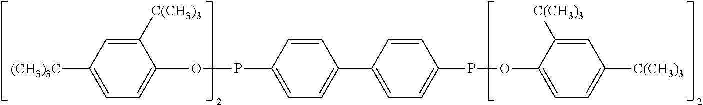

Suitable secondary antioxidants are also organo-sulphur compounds, such as for example sulphides and disulphides, for example distearyl thiodipropionate, dilauryl thiodipropionate, ditridecyl dithiopropionate, ditetradecyl thiodipropionate, 3-(dodecylthio)-, 1,1′-[2,2-bis[[3-(dodecylthio)-1-oxopropoxy]methyl]-1,3-propanediyl]propanoic acid ester. The following structures are preferred:

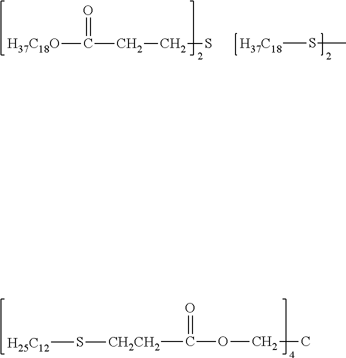

Suitable acid scavengers (“antiacids”) are salts of monovalent, divalent, trivalent or tetravalent metals, preferably alkali metals, alkaline earth metals, aluminium or zinc, in particular formed with fatty acids, such as for example calcium stearate, magnesium stearate, zinc stearate, aluminium stearate, calcium laurate, calcium behenate, calcium lactate, calcium stearoyl-2-lactate. Other classes of suitable acid scavengers are hydrotalcites, especially synthetic hydrotalcites based on aluminium, magnesium and zinc, hydrocalumites, zeolites, alkaline earth oxides, especially calcium oxide and magnesium oxide as well as zinc oxide, alkaline earth carbonates, especially calcium carbonate, magnesium carbonate and dolomite, and hydroxides, especially brucite (magnesium hydroxide),

Suitable costabilizers are also polyols, in particular alditols or cyclitols. Polyols are, for example, pentaerythritol, dipentaerythritol, tripentaerythritol, short chain polyether polyols or polyester polyols, as well as hyperbranched polymers/oligomers or dendrimers with alcohol groups, for example

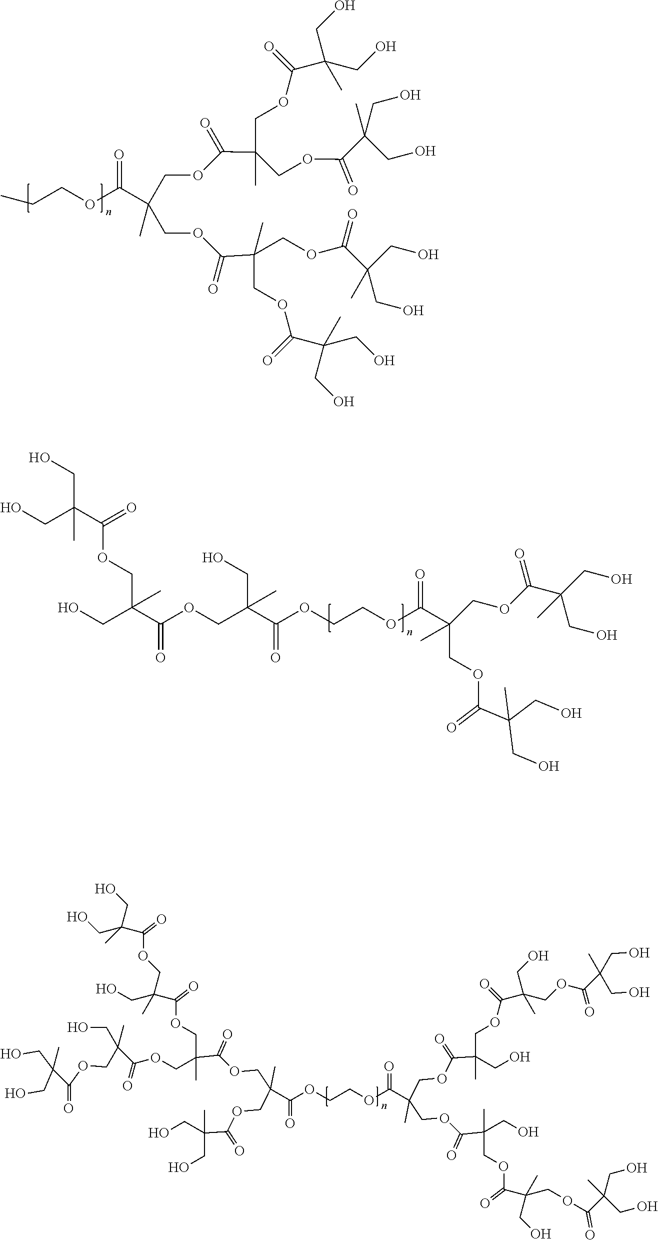

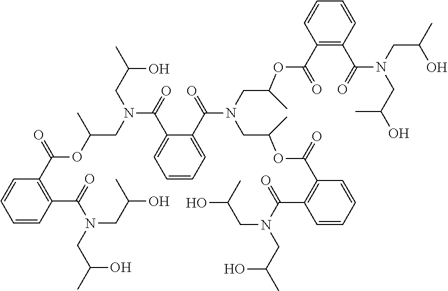 [SMILES: CC(O)CN(CC(C)O)C(=O)c1ccccc1C(=O)OC(C)CN(CC(C)O)C(=O)c1ccccc1C(=O)N(CC(C)OC(=O)c1ccccc1C(=O)N(CC(C)O)CC(C)O)CC(C)OC(=O)c1ccccc1C(=O)N(CC(C)O)CC(C)O]

Preferably, the at least one alditol is selected from the group consisting of threitol, erythritol, galactitol, mannitol, ribitol, sorbitol, xylitol, arabitol, isomalt, lactitol, maltitol, altritol, iditol, maltotritol, and hydrogenated oligo- and polysaccharides having polyol end groups, and mixtures thereof. Particularly preferred is the at least one preferred alditol selected from the group consisting of erythritol, mannitol, isomalt, maltitol and mixtures thereof.

Examples of other suitable sugar alcohols are heptitols and octitols: meso-glycero-allo heptitol, D-glycero-D-altro heptitol, D-glycero-D-manno heptitol, meso-glycero-gulo heptitol, D-glycero-D-galacto heptitol (perseitol), D-glycero-D-gluco heptitol, L-glycero-D-gluco heptitol, D-erythro-L-galacto-octitol, D-threo-L-galacto-octitol.

In particular, the at least one cyclitol may be selected from the group consisting of inositol (myo, scyllo-, D-chiro-, L-chiro-, muco-, neo-, allo-, epi- and cis-inositol), 1,2,3,4-tetrahydroxycyclohexane, 1,2,3,4,5-pentahydroxycyclohexane, quercitol, viscumitol, bornesitol, conduritol, ononitol, pinitol, pinpollitol, quebrachitol, ciceritol, quinic acid, shikimic acid and valienol; myo-inositol is preferred here.

Suitable light stabilizers are, for example, compounds based on 2-(2′-hydroxyphenyl)benzotriazoles, 2-hydroxybenzophenones, esters of benzoic acids, acrylates, oxamides and 2-(2-hydroxyphenyl)-1,3,5-triazines.

Suitable 2-(2′-hydroxyphenyl)benzotriazoles include, for example, 2-(2′-hydroxy-5′methylphenyl)benzotriazole, 2-(3′,5′-di-tert-butyl-2′-hydroxyphenyl)benzotriazole, 2-(5′-tert-butyl-2′-hydroxy-phenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl-5-chlorobenzotriazole, 2-(3′-sec-butyl-5′-tert-butyl-2′-hydroxy-phenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonyl-ethyl]-2′-hydroxyphenyl)-5-chlorobenzotriazole, 2-(3′-tert-butyl-2′-hydroxy-5′-(2-methoxycarbonyl-ethyl)phenyl)-5-chlorobenzotriazole, 2-(3′-tert-butyl-2′-hydroxy-5′-(2-methoxycarbony-lethyl)phenyl)-benzotriazole, 2-(3′-tert-butyl-2′-hydroxy-5′-(2-octyloxycarbonylethyl)-phenyl)-benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)-phenyl-benzotriazole, 2,2′-methylenebis[4-(1,1,3,3-tetramethylbutyl)-6-benzotriazol-2-ylphenol]; the product of the re-esterification of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂—]—₂, wherein R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]-benzotriazole, 2-[2′-hydroxy-3′-(1,1,3,3-tetramethylbutyl)-5′-(α,α-dimethylbenzyl)phenyl]benzotriazole.

Suitable 2-hydroxybenzophenones are, for example, 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethyoxy derivatives of 2-hydroxybenzophenones.

Suitable acrylates are, for example, ethyl-α-cyano-β,β-diphenyl acrylate, isooctyl-α-cyano-β,β-diphenyl acrylate, methyl-α-carbomethoxycinnamate, methyl-α-cyano-β-methyl-p-methoxycinnamate, butyl-α-cyano-β-methyl-p-methoxycinnamate, methyl-α-carbomethoxy-p-methoxycinnamate and N-(β-carbomethoxy-β-cyanovinyl)-2-methylindoline.

Suitable esters of benzoic acids include 4-tert-butylphenylsalicylate, phenylsalicylate, octylphenylsalicylate, dibenzoylresorcinol, bis(4-tert-butylbenzoyl)resorcinol, benzoylresorcinol, 2,4-di-tert-butylphenyl-3,5-di-tert-butyl-4-hydroxybenzoate, hexadecyl-3,5-di-tert-butyl-4-hydroxy-benzoate, octadecyl-3,5-di-tert-butyl-4-hydroxybenzoate, 2-methyl-4,6-di-tert-butylphenyl-3,5-di-tert-butyl-4-hydroxybenzoate.

Suitable oxamides are, for example, 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and mixtures thereof with 2-ethoxy-2′-ethyl-5,4′-di-tert-butoxanilide, mixtures of o- and p-methoxy-disubstituted oxanilides and mixtures of o- and p-ethoxy-disubstituted oxanilides.

Suitable 2-(2-hydroxyphenyl)-1,3,5-triazines are, for example, 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)-phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl-1,3,5-triazine.

Suitable metal deactivators are, for example, N,N′-diphenyloxamide, N-salicylal-N′-salicyloylhydrazine, N,N′-bis(salicyloyl)hydrazine, N,N′-bis(3,5-di-tert-butyl-4-hydroxy-phenyl-propionyl)hydrazine, 3-salicyloylamino-1,2,4-triazole, bis(benzylidene)oxalyldihydrazide, oxanilide, isophthaloyldihydrazide, sebacoylbisphenylhydrazide, N,N′-diacetyladipoyldihydrazide, N,N′-bis(salicyloyl)oxylyldihydrazide, N,N′-bis(salicyloyl)thiopropionyldihydrazide.

Particularly preferred metal deactivators are:

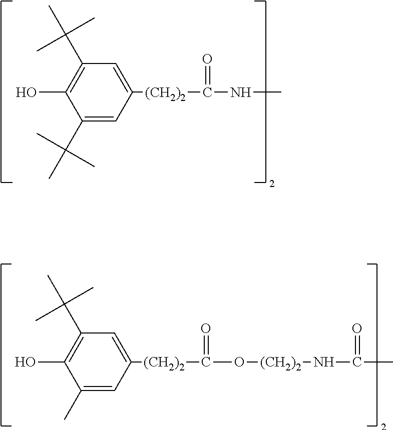

Suitable low-molecular-weight hindered amines are, for example,
1,1-bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl)-n-butyl-3,5-di-tert-butyl-4-hydroxybenzylmalonate, the condensation product of 1-(2-hydroxyethyl)-2,2,6,6-tetramethyl-4-hydroxypiperidine and succinic acid, linear or cyclic condensation products of N,N′-bis(2,2,6,6-tetramethyl-4-piperidyl)hexamethylene diamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine or 4-stearyloxy-2,2,6,6-tetramethylpiperidine.

The above-mentioned structures also include, in each case, the sterically hindered N-H, N-alkyl, such as N-methyl or N-octyl, the N-alkoxy derivatives, such as N-methoxy or N-octyloxy, the cycloalkyl derivatives, such as N-cyclohexyloxy and the N-(2-hydroxy-2-methylpropoxy) analogues.

Preferred low-molecular-weight hindered amines furthermore have the following structures:

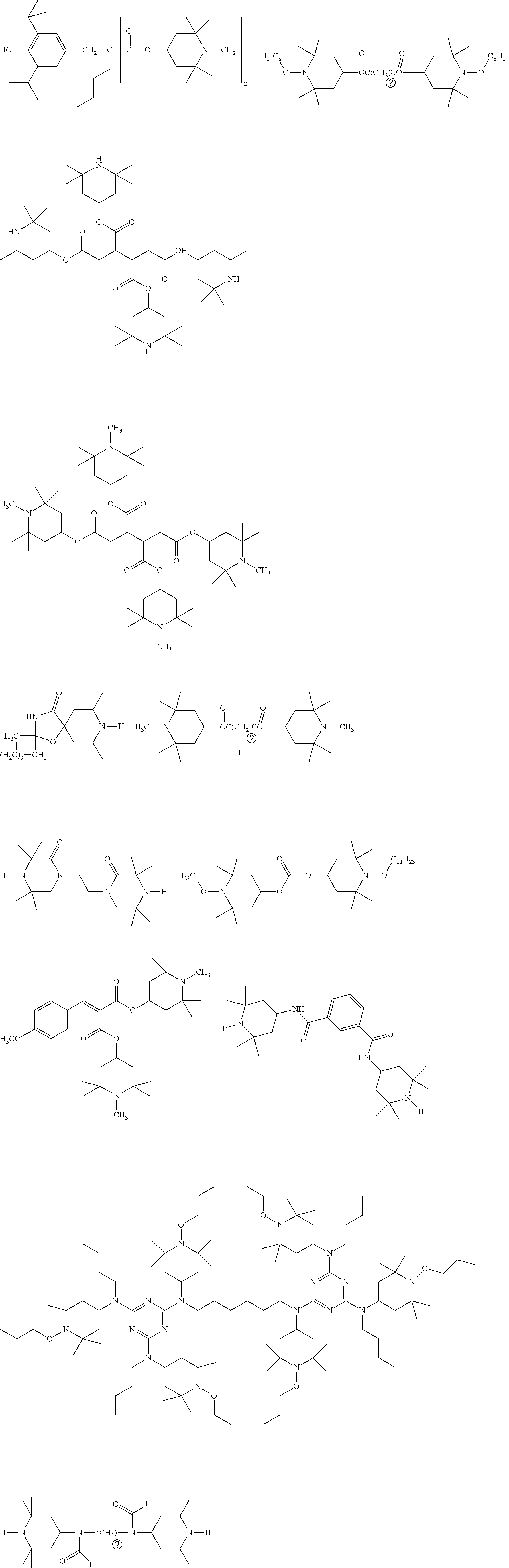

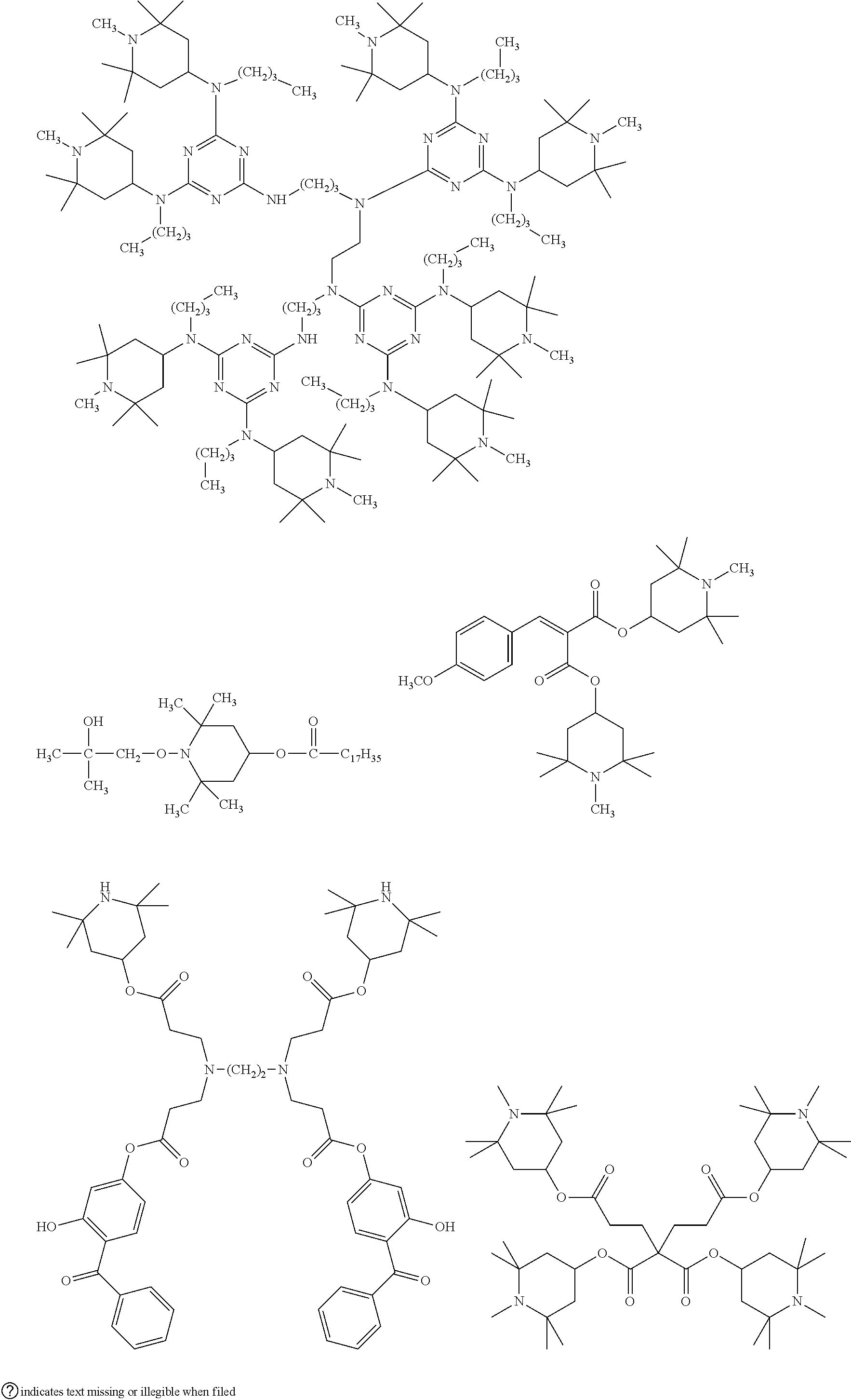

Preferred oligomeric or polymeric hindered amines are:

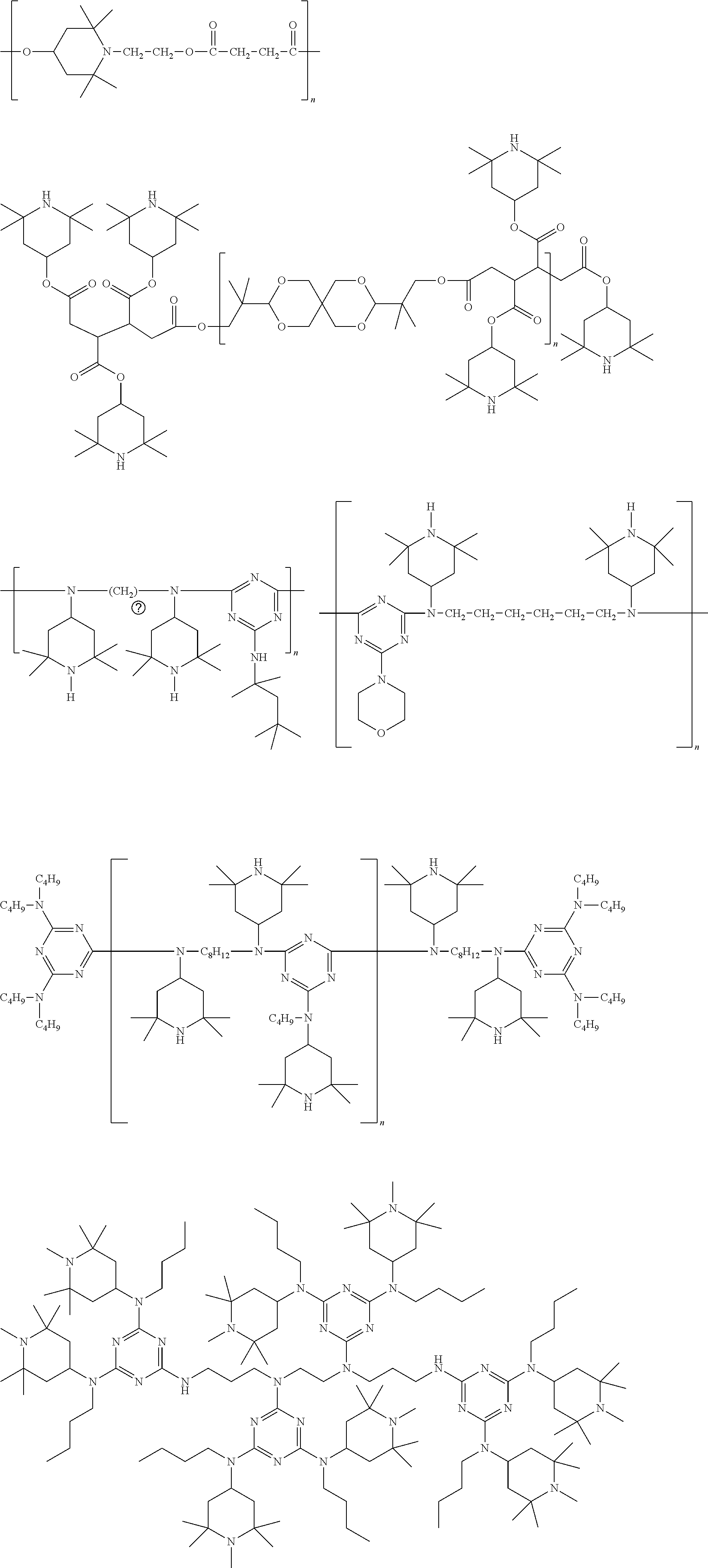

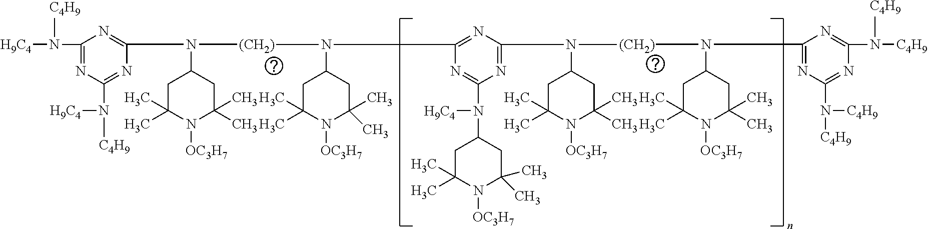

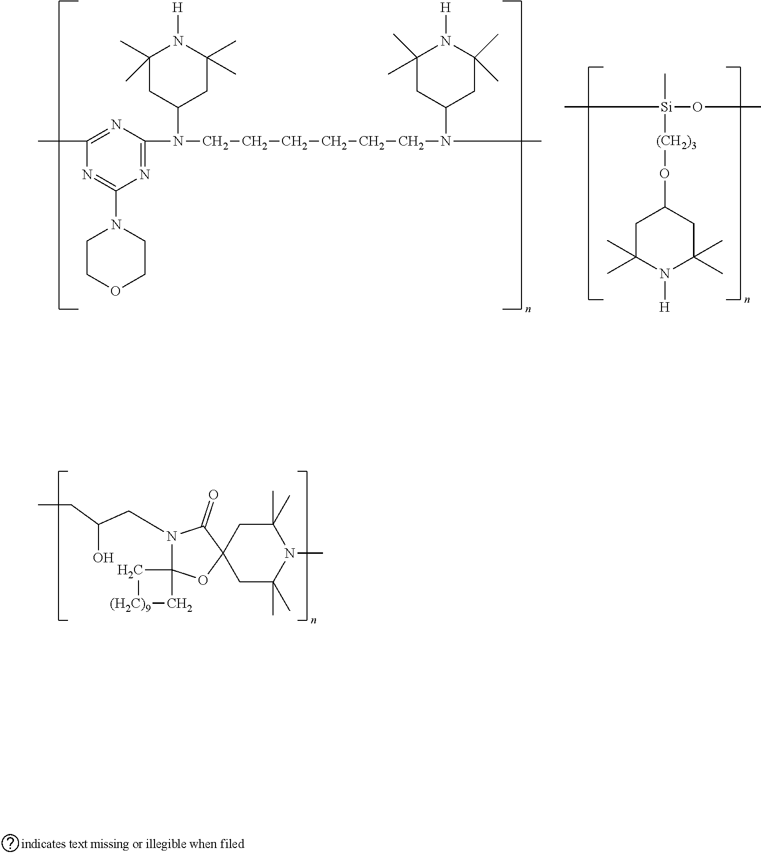

For the previously mentioned compounds, n means 3 to 100 in each case.

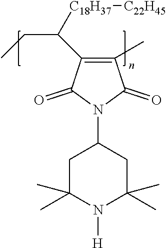

Another suitable light stabilizer is Hostanox NOW (manufacturer: Clariant SE) with the following general structure:

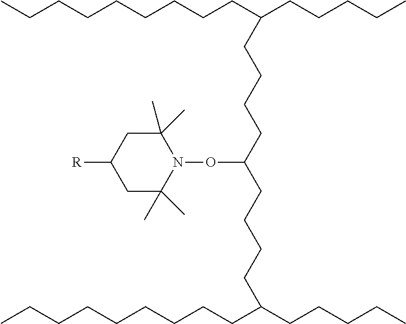

wherein R means —O—C(O)—C₁₅H₃₁ or —O—C(O)—C₁₇H₃₅.

The above-mentioned structures also include, in each case, the sterically hindered N-H, N-alkyl, such as N-methyl or N-octyl, the N-alkoxy derivatives, such as N-methoxy or N-octyloxy, the cycloalkyl derivatives, such as N-cyclohexyloxy and the N-(2-hydroxy-2-methylpropoxy) analogues.

Suitable dispersants are, for example:
Polyacrylates, for example copolymers with long-chain side groups, polyacrylate block copolymers, alkylamides: for example N,N′-1,2-ethanediylbisoctadecanamide sorbitan esters, for example monostearyl sorbitan esters, titanates and zirconates, reactive copolymers with functional groups, for example polypropylene-co-acrylic acid, polypropylene-co-maleic anhydride, polyethylene-co-glycidyl methacrylate, polystyrene-alt-maleic anhydride polysiloxanes: for example dimethylsilanediol-ethylene oxide copolymer, polyphenylsiloxane copolymer, amphiphilic copolymers: for example polyethylene-block-polyethylene polyethylene oxide, dendrimers, for example dendrimers containing hydroxyl groups.

Suitable anti-nucleating agents are azine dyes, such as nigrosine.

Suitable flame retardants are, in particular
a) Inorganic flame retardants, such as for example Al(OH)₃, Mg(OH)₂, AlO(OH), MgCO₃, layered silicates, such as for example montmorillonite or sepiolite, unmodified or organically modified, double salts, such as for example Mg-Al-silicates, POSS (Polyhedral Oligomeric Silsesquioxane) compounds, huntite, hydromagnesite or halloysite as well as Sb₂O₃, Sb₂O₅, MoO₃, zinc stannate, zinc hydroxystannate,
b) nitrogen-containing flame retardants such as melamine, melem, melam, melon, melamine derivatives, melamine condensation products or melamine salts, benzoguanamine, polyisocyanurates, allantoin, phosphacenes, in particular melamine cyanurate, melamine phosphate, dimelamine phosphate, melamine pyrophosphate, melamine polyphosphate, melamine metal phosphates, such as for example melamine aluminium phosphate, melamine zinc phosphate, melamine magnesium phosphate, and the corresponding pyrophosphates and polyphosphates, poly-[2,4-(piperazin-1,4-yl)-6-(morpholin-4-yl)-1,3,5-triazine], ammonium polyphosphate, melamine borate, melamine hydrobromide,
c) radical formers, such as alkoxyamines, hydroxylamine esters, azo compounds, sulfenamides, sulfenimides, dicumyl or polycumyl, hydroxyimides and their derivatives, such as for example hydroxyimide esters or hydroxyimide ethers
d) Phosphorus-containing flame retardants, such as for example red phosphorus, phosphates, such as for example resorcinol diphosphate, bisphenol A diphosphate and its oligomers, triphenyl phosphate, ethylenediamine diphosphate, phosphinates, such as for example salts of hypophosphorous acid and their derivatives, such as alkyl phosphinate salts, for example diethyl phosphinate aluminium or diethyl phosphinate zinc or aluminium phosphinate, aluminium phosphite, aluminium phosphonate, phosphonate esters, oligomeric and polymeric derivatives of methane phosphonic acid, 9,10-dihydro-9-oxa-10-phosphorylphenanthrene-10-oxide (DOPO) and substituted compounds thereof,
e) Halogen-containing chlorine- and bromine-based flame retardants, such as for example polybrominated diphenyl oxides, such as for example decabromodiphenyloxide,tris(3-bromo-2,2-bis(bromomethyl)propyl-phosphate, tris(tribromneopentyl)phosphate, tetrabromophthalic acid, 1,2-bis(tribromophenoxy)ethane, hexabromocyclododecane, brominated diphenylethane, tris-(2,3-dibromopropyl)isocyanurate, ethylene-bis(tetrabromophthalimide), tetrabromo-bisphenol A, brominated polystyrene, brominated polybutadiene or polystyrene-brominated polybutadiene copolymers, brominated polyphenylene ether, brominated epoxy resin, polypentabromobenzyl acrylate, optionally in combination with Sb₂O₃ and/or Sb₂O₅,
f) borates, such as for example zinc borate or calcium borate, optionally on a carrier material such as silica
g) sulphur-containing compounds, such as for example elemental sulphur, disulphides and polysulphides, thiuram sulphide, dithiocarbamates, mercaptobenzthiazole and sulfenamides,
h) anti-drip agents, such as for example polytetrafluoroethylene,
i) silicon-containing compounds, such as for example polyphenylsiloxanes,
j) carbon modifications, such as for example carbon nanotubes (CNT), expanded graphite or graphene
k) and combinations or mixtures thereof.

Suitable plasticizers are, for example, phthalic acid esters, adipic acid esters, esters of citric acid, esters of 1,2-cyclohexanedicarboxylic acid, trimellitic acid esters, isosorbide esters, phosphate esters, epoxides such as epoxidized soybean oil or aliphatic polyesters.

Suitable lubricants and processing aids are, for example, polyethylene waxes, polypropylene waxes, salts of fatty acids such as calcium stearate, zinc stearate or salts of montan waxes, amide waxes such as erucic acid amide or oleic acid amides, fluoropolymers, silicones or neoalkoxytitanates and zirconates.

Suitable pigments may be inorganic or organic in nature. Inorganic pigments are, for example, titanium dioxide, zinc oxide, zinc sulphide, iron oxide, ultramarine, carbon black, organic pigments are, for example, anthraquinones, anthanthrones, benzimidazolones, quinacridones, diketopyrrolopyrroles, dioxazines, indanthrones, isoindolinones, azo compounds, perylenes, phthalocyanines or pyranthrones. Other suitable pigments are metal-based effect pigments or metal-oxide-based pearlescent pigments.

Suitable optical brighteners are, for example, bisbenzoxazoles, phenylcoumarins or bis(styryl)biphenyls, and in particular optical brighteners of the formulae:

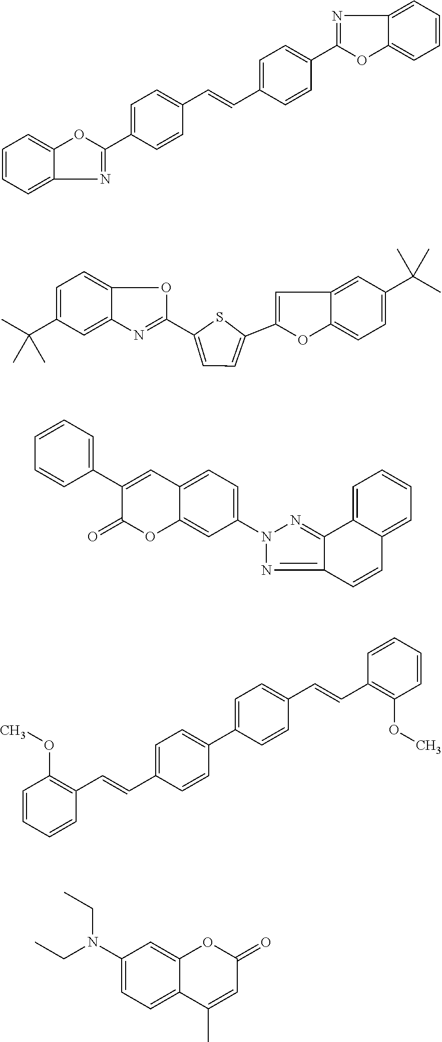

Suitable filler deactivators are, for example, polysiloxanes, polyacrylates, in particular block copolymers such as polymethacrylic acid-polyalkylene oxide or polyglycidyl (meth)acrylates and their copolymers, for example with styrene, and epoxides, for example of the following structures:

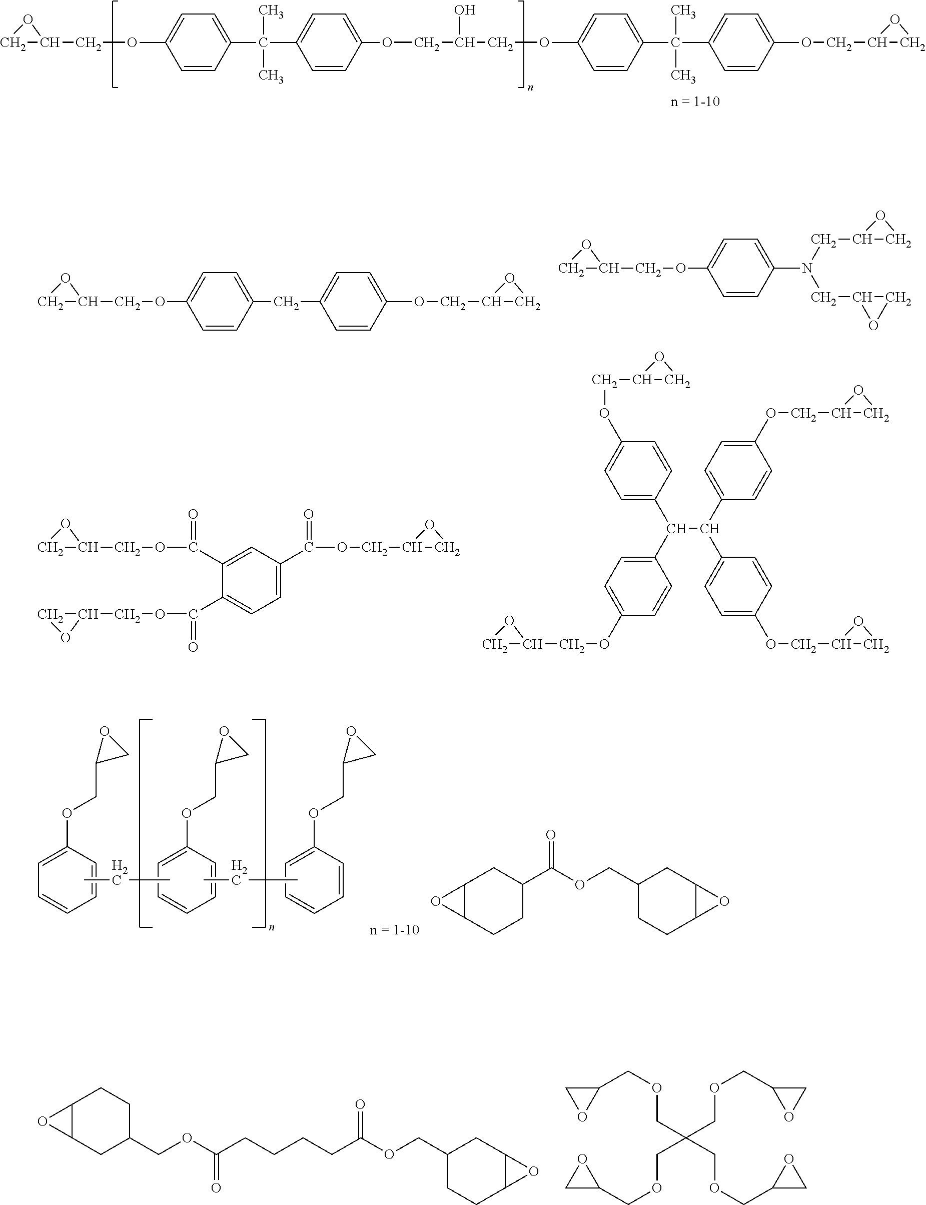

Suitable antistatic agents are, for example, ethoxylated alkylamines, fatty acid esters, alkyl sulphonates and polymers such as polyetheramides.

Suitable antiozonants are the above-mentioned amines such as, N,N′-diisopropyl-p-phenylenediamine, N,N′-di-sec-butyl-p-phenylenediamine, N,N′-bis(1,4-dimethylpentyl)-p-phenylenediamine, N,N′-dicyclohexyl-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine.

Suitable nucleating agents are talc, alkali or alkaline earth salts of mono- and polyfunctional carboxylic acids, such as for example benzoic acid, succinic acid, adipic acid, for example sodium benzoate, zinc glycerolate, aluminium hydroxy-bis(4-tert-butyl)benzoate, 2,2′-methylene-bis-(4,6-di-tert-butylphenyl)phosphate, as well as trisamides and diamides, such as for example trimesic acid tricyclohexylamide, trimesic acid tri(4-methylcyclohexylamide), trimesic acid tri(tert.butylamide), N,N′,N″-1,3,5-benzenetriyltris(2,2-dimethyl-propanamide) or 2,6-naphthalenedicarboxylic acid dicyclohexylamide.

Suitable additives for the molecular weight build-up of polycondensation polymers (chain extenders) are diepoxides, bis-oxazolines, bis-oxazolones, bis-oxazines, diisocyanates, dianhydrides, bis-acyl lactams, bis-maleimides, dicyanates, carbodiimides. Other suitable chain extenders are polymeric compounds, such as for example polystyrene-polyacrylate-polyglycidyl (meth)acrylate copolymers, polystyrene-maleic anhydride copolymers and polyethylene-maleic anhydride copolymers.

Suitable additives for increasing electrical conductivity are, for example, the aforementioned antistatic agents, carbon black and carbon compounds such as carbon nanotubes and graphene, metal powders, such as for example copper powder, and conductive polymers, such as for example polypyrroles, polyanilines and polythiophenes. Suitable additives for increasing the thermal conductivity are, for example, aluminonitrides and boron nitrides.

Suitable infrared-active additives are, for example, aluminosilicates, hydrotalcites or colouring agents such as phthalocyanines or anthraquinones.

Suitable demoulding aids are, for example, silicones, soaps and waxes such as montan waxes.

The incorporation of the additive composition described above and, if applicable, the additional additives into the plastic is carried out by conventional processing methods, wherein the polymer is melted and mixed with the additive composition according to the invention and the additional additives, if applicable, preferably by mixer, kneader or extruder. Preferred processing machines are extruders such as single screw extruders, twin screw extruders, planetary roller extruders, ring extruders, and co-kneaders, which are preferably equipped with vacuum degassing. The processing may take place here under air or, if necessary, under inert gas conditions.

Furthermore, the additive compositions according to the invention may be prepared and incorporated in the form of so-called masterbatches or concentrates containing, for example, 10-90% of the compositions according to the invention in a polymer.

Furthermore, the present invention relates to a moulded part or a moulded article which is producible from a hydrolysis-stabilized composition according to the present invention. In particular, the moulded part or the moulded article is selected from the group consisting of foils, films, foams, fibres, cables and tubes, profiles, hollow bodies, tapes, membranes, such as geomembranes, or adhesives, which are produced via extrusion, injection moulding, blow moulding, calendering, pressing processes, spinning processes, rotomoulding, for example for the electrical and electronics industry, the construction industry, the transport industry (car, plane, ship, railway), for medical applications, for household and electrical appliances, vehicle parts, consumer articles, packaging, furniture, textiles.

The present invention is explained in greater detail with reference to the following examples, without the examples being construed as limiting for the subject matter of the present invention.

### EMBODIMENTS

The following additions were used in the examples:
Hydrotalcite 1: Actilox CAH EXP 0213; supplier: Nabaltec
Hydrotalcite 2: DHT-4C; supplier: Kisuma Chemicals, calcined version of DHT-4A
Hydrotalcite 3: Hycite 713; supplier: Clariant SE
Hydrotalcite 4: Sorbacid 911; supplier: Clariant SE
Hydrotalcite 5: DHT-4A; supplier: Kisuma Chemicals

The zeolite used was a molecular sieve type 13X from AlfaAesar.

The aziridine is the POLY-U Powder of the manufacturer Menadiona. The chemical name is N,N′-(methylenedi-p-phenylene)bis(aziridine-1-carboxamide).

To test the effect of the stabilizer composition according to the invention, a polylactide (PLA) (Luminy L130, supplier: Total Corbion) together with the additives listed in Table 1 was compounded at 200° C. max. in a twin screw extruder (Process 11, manufacturer ThermoScientific) at a throughput of 800 g/h. Polymer and additives were dried overnight in a vacuum dryer before processing. After compounding, the compounds were aged in deionised water at 60° C. in a heating cabinet for 2 weeks (336 hours). After ageing, the samples were dried overnight and the MVR was determined (190° C./2.16 kg).

TABLE 1
Hydrolysis stability of PLA

| | | | MVR change |
|---|---|---|---|
| | | MVR after | after water |
| | | compounding | storage (14 |
| | Additions | [cm³/10 min] | days) [%] |
| Comparative | Without addition | 10.77 | +9000 |
| example 1 | | | |
| Comparative | Aziridine (2.0%) | 14.86 | +33 |
| example 2 | | | |
| Comparative | Hydrotalcite 1 (2.0%) | 10.50 | +250 |
| example 3 | | | |
| Comparative | Zeolite (2.0%) | 12.03 | +920 |
| example 4 | | | |
| Example 1 | Aziridine (0.5%) + | 8.76 | +29 |
| according to | hydrotalcite 1 (1.5%) | | |
| the invention | | | |
| Example 2 | Aziridine (1.0%) + | 10.18 | +13 |
| according to | hydrotalcite 1 (1.0%) | | |
| the invention | | | |
| Example 3 | Aziridine (0.5%) + | 10.08 | +64 |
| according to | hydrotalcite 2 (1.5%) | | |
| the invention | | | |
| Example 4 | Aziridine (0.5%) + | 11.39 | +120 |
| according to | hydrotalcite 3 (1.5%) | | |
| the invention | | | |
| Example 5 | Aziridine (0.5%) + | 10.93 | +106 |
| according to | hydrotalcite 4 (1.5%) | | |
| the invention | | | |
| Example 6 | Aziridine (0.5%) + | 6.94 | +250 |
| according to | zeolite (1.5%) | | |
| the invention | | | |
| Example 7 | Aziridine (1.0%) + | 7.23 | +58 |
| according to | zeolite (1.0%) | | |
| the invention | | | |

To test the effect of the stabilizer composition according to the invention, a polybutylene terephthalate (PBT) (Pocan B1204, supplier: Lanxess) together with the additives listed in Table 2 was compounded at 245° C. max. in a twin screw extruder (Process 11, manufacturer ThermoScientific) at a throughput of 800 g/h. Polymer and additives were dried overnight in a vacuum dryer before processing. After compounding, the compounds were aged in deionized water at 85° C. in a heating cabinet for 2 weeks (336 hours). After ageing, the samples were dried overnight and the MVR was determined (250° C./2.16 kg).

TABLE 2
Hydrolysis stability of PBT

| | | | MVR change |
|---|---|---|---|
| | | MVR after | after water |
| | | compounding | storage (14 |
| | Additions | [cm³/10 min] | days) [%] |
| Comparative | Without addition | 53.65 | +75 |
| example 1 | | | |
| Comparative | Aziridine (2.0%) | 13.22 | +66 |
| example 2 | | | |
| Comparative | Hydrotalcite 2 (2.0%) | 58.57 | +144 |
| example 3 | | | |
| Example 1 | Aziridine (0.5%) + | 38.76 | +11 |
| according to | hydrotalcite 1 (1.5%) | | |
| the invention | | | |
| Example 2 | Aziridine (0.5%) + | 37.00 | +39 |
| according to | hydrotalcite 2 (1.5%) | | |
| the invention | | | |
| Example 3 | Aziridine (0.5%) + | 48.10 | +51 |
| according to | hydrotalcite 3 (1.5%) | | |
| the invention | | | |
| Example 4 | Aziridine (0.5%) + | 52.05 | +50 |
| according to | hydrotalcite 5 (1.5%) | | |
| the invention | | | |
| Example 5 | Aziridine (0.5%) + | 38.09 | +53 |
| according to | zeolite (1.5%) | | |
| the invention | | | |

To test the effect of the stabilizer composition according to the invention, a polyamide 6 (PA6) (Ultramid B27E, supplier: BASF) together with the additives listed in Table 3 was compounded at 245° C. max. in a microcompounder (Micro 5cc Twin Screw Extruder, manufacturer DSM). Polymer and additives were dried overnight in a vacuum dryer before processing. After compounding, the compounds were aged in deionized water at 85° C. in a heating cabinet for 2 weeks (336 hours). After ageing, the samples were dried overnight and the molecular weight was determined by GPC.

TABLE 3
Hydrolysis stability of PA6

| | | Mₙ after | Mₙ change after |
|---|---|---|---|
| | | compounding | water storage |
| | Additions | [g/mol] | (14 days) [%] |
| Comparative | Without addition | 28,805 | −31 |
| example 1 | | | |
| Example 1 | Aziridine (0.5%) + | 34,201 | −11 |
| according to | hydrotalcite 1(1.5%) | | |
| the invention | | | |
| Example 2 | Aziridine (0.5%) + | 34,154 | −7 |
| according to | hydrotalcite 2 (1.5%) | | |
| the invention | | | |

The MVR is a measure of the molecular weight of the polymer. The higher the MVR, the lower the molecular weight and thus the degradation of the polymer by hydrolysis. The lower the MVR increase, the higher the hydrolysis stability. The combinations according to the invention thus show excellent hydrolysis stability.

1-17. (canceled)

18. A stabilizer composition consisting of
at least one aziridine and
one or more of hydrotalcite, zeolite, and dawsonite.

19. The stabilizer composition according to claim 18, wherein the at least one aziridine is selected from the group consisting of monofunctional, difunctional, trifunctional, tetrafunctional, and multifunctional aziridines.

20. The stabilizer composition according to claim 19, wherein:
(A) the monofunctional aziridine is
1-aziridinecarboxamide, N-octadecyl-;
1-aziridinecarboxamide, N-phenyl-;
1-aziridinecarboxamide, N-cyclohexyl-;
1-aziridinecarboxamide, N-1-naphthalenyl-;
1-aziridinecarboxamide, N-decyl-;
N-benzyloxycarbonylaziridine;
(4-methoxyphenyl)(2-methyl-1-aziridinyl)methanone;
N-(4-cyclohexylphenyl)-1-aziridinecarboxamide;
2-[2-(1-aziridinyl)ethoxy]-4-pyridinepyridinecarboxylic acid;
6-[2-(1-aziridinyl)ethoxy]-3-pyridinemethanamine;
6-[2-(1-aziridinyl)ethoxy]-2-pyridinepyridinecarboxylic acid;
2-[2-(1-aziridinyl)ethoxy]pyridine;
2-methyl-aziridine;
2-[1-(1-aziridinylmethyl)propoxy]-pyridine; or
2-[2-(1-aziridinyl)ethoxy]-4-pyridinemethanamine;
(B) the difunctional aziridine is
N,N′-hexamethylene-1,6-bis(1-aziridinecarboxamide);
N,N′-(methylenedi-p-phenylene)bis(aziridine-1-carboxamide);
N,N′-(methylenedi-4,1-phenylene)bis[2-methyl-1-aziridinecarboxamide];
1-aziridinecarboxamide, N,N′-(3,3′-dimethyl[1,1′-biphenyl]-4,4′-diyl)bis-;
1-aziridinecarboxamide, N,N′-[1,1′-biphenyl]-4,4′-diylbis-;
1-aziridinecarboxamide, N,N′-(methylenedi-4,1-phenylene)bis-;
1-aziridinecarboxamide, N,N′-(4-methyl-1,3-phenylene)bis-;
1-aziridinecarboxamide, N,N′-(1,4-phenylenedi-2,1-ethanediyl)bis-;
1-aziridinecarboxamide, N,N′-1,4-phenylenebis-;
N,N′-(hexane-1,6-diyl)bis(2-methylaziridine-1-carboxamide);
N,N′-1,2-ethanediylbis[1-aziridinecarboxamide];
N,N′-1,3-propanediylbis[1-aziridinecarboxamide];
N,N′-1,4-butanediylbis[1-aziridinecarboxamide];
N,N′-1,5-pentanediylbis[1-aziridinecarboxamide];
N,N′-1,6-hexanediylbis[1-aziridinecarboxamide];
N,N′-1,7-heptanediylbis[1-aziridinecarboxamide];
N,N′-1,8-octanediylbis[1-aziridinecarboxamide];
N,N′-1,9-nonanediylbis[1-aziridinecarboxamide];
N,N′-1,10-decanediylbis[1-aziridinecarboxamide];
1-aziridinecarboxamide, N,N′-(3-hydroxy-1,5-pentanediyl)bis- 1-aziridinecarboxamide,
N,N′-1,5-naphthalenediylbis-;
1-aziridinecarboxamide, N,N′-(3,3′-dimethoxy[1,1′-biphenyl]-4,4′-diyl)bis-;
1-aziridinecarboxamide, N,N′-(methyl-1,3-phenylene)bis-;
1-aziridinecarboxamide, N,N′-[1,1′-biphenyl]-4,4′-diylbis-;
poly(oxy-1,4-butanediyl),α-[[[3-[(1-aziridinylcarbonyl)amino]-4-methylphenyl]amino]carbonyl]-ω-[[[[3-[(1-aziridinylcarbonyl)amino]-4-methylphenyl]amino]carbonyl]oxy]-; or
N,N″-(methylenedi-4,1-phenylene)bis[N′-1-aziridinyl urea;
(C) the trifunctional aziridine is:
pentaerythritol tris[3-(1-aziridinyl)propionate];
trimethylolpropane tris[3-(2-methylaziridin-1-yl)propionate];
trimethylolpropane tris[3-(aziridin-1-yl)propionate];
1-aziridine propionic acid, 2-[[3-(1-aziridinyl)-1-oxopropoxy]methyl]-1,3-propanediyl ester;
1-aziridine propionic acid, α-methyl, 1,1′-[2-[[3-(1-aziridinyl)-2-methyl-1-oxopropoxy]methyl]-2-ethyl-1,3-propanediyl]ester;
1-aziridine propionic acid, 2-[[(1-aziridinylacetyl)oxy]methyl]-2-ethyl-1,3-propanediyl ester;
1-aziridine propionic acid, 2-methyl-, 1,1′,1″-(2-ethyl-1,2,3-propanetriyl) ester;
1-aziridinecarboxamide, N,N′,N″-(methylidynetri-4,1-phenylene)tris;
1-aziridinecarboxamide, N,N′-[[[6-[(1-aziridinylcarbonyl)amino]hexyl]imino]bis(carbonylimino-6,1-hexanediyl)]bis-;
1-aziridine propionic acid, 2-methyl, 1,1′-[2-ethyl-2-[[3-(2-methyl-1-aziridinyl)-1-oxopropoxy]methyl]-1,3-propanediyl]ester;
1-aziridine propionic acid, 1,1′-[2-[[3-(1-aziridinyl)-1-oxopropoxy]methyl]-2-ethyl-1,3-propanediyl]ester;
1-aziridine propionic acid, 1,1′-[2-[[3-(1-aziridinyl)-1-oxopropoxy]methyl]-2-(hydroxymethyl)-1,3-propanediyl]ester;
poly(oxy-1,2-ethanediyl), α,α′,α″-1,2,3-propanetriyltris[ω-[[[[3-[(1-aziridinylcarbonyl)amino]-4-methylphenyl]amino]carbonyl]oxy]-; or
aziridine, 1,1′,1″-(s-phenenyltricarbonyl)tris[2-methyl]-;
(D) the tetrafunctional aziridine is:
pentaerythritol tetrakis(β-aziridino)propionate;
1-aziridine propionic acid, 1,1′-[2,2-bis[[3-(1-aziridinyl)-1-oxopropoxy]methyl]-1,3-propanediyl]ester;
1-aziridine propionic acid, 2-methyl, 1,1′-[2,2-bis[[3-(2-methyl-1-aziridinyl)-1-oxopropoxy]methyl]-1,3-propanediyl]ester;
1-aziridine ethanol, α,α′-[[2,2-bis[2-hydroxy-3-(2-methyl-1-aziridinyl)propoxy]methyl]-1,3-propanediyl]bis(oxymethylene)]bis[2-methyl-;
ethanone, 2,2′,2″,2′″-[[2,2′-bipyridine]-6,6′-diylbis(methylenenitrilo)]tetrakis[1-(2-methyl-1-aziridinyl)-;
1,5-pentandione, 2-[bis[2-(2-methyl-1-aziridinyl)-2-oxoethyl]amino]-1,5-bis(2-methyl-1-aziridinyl)-;
ethanone, 2,2′,2″,2′″-(1,2-ethanediyldinitrilo)tetrakis[1-(2-methyl-1-aziridinyl)-;
methanone, 1,1′,1″,1′″-(1,4,5,8-naphthalenetetrayl)tetrakis[1-(2-methyl-1-aziridinyl)-; or
1-aziridine ethanol, α,α′-[[2,2-bis[2-hydroxy-3-(2-methyl-1-aziridinyl)propoxy]methyl]-1,3-propanediyl]bis(oxymethylene)]bis[2-methyl-; and
(E) the multifunctional aziridine is:
1-aziridine propionic acid, 1,1′-[2-[[3-[3-(1-aziridinyl)-1-oxopropoxy]-2,2-bis[[3-(1-aziridinyl)-1-oxopropoxy]methyl]propoxy]methyl]- 2-[[3-(1-aziridinyl)-1-oxopropoxy]methyl]-1,3-propandiyl]ester;
1-aziridine propionic acid, 2-methyl-, 1,1′-[2-[[3-[3-(1-aziridinyl)-1-oxopropoxy]-2-(hydroxymethyl)-2-[[3-(2-methyl-1- aziridinyl)-1-oxopropoxy]methyl]propoxy]methyl]-2-[[3-(2-methyl-1-aziridinyl)-1-oxopropoxy]methyl]-1,3-propandiyl]ester;
1-aziridine propionic acid, β,2-dimethyl, benzylhexaylhexamethylene ester;
1-aziridine propionic acid, 2-ethyl-β-methyl, or benzylhexaylhexakis(methylene)ester;
wherein the composition optionally comprises a combination of two or more of the above aziridines.

21. The stabilizer composition according to claim 18, wherein the at least one aziridine is selected from the group consisting of the following compounds

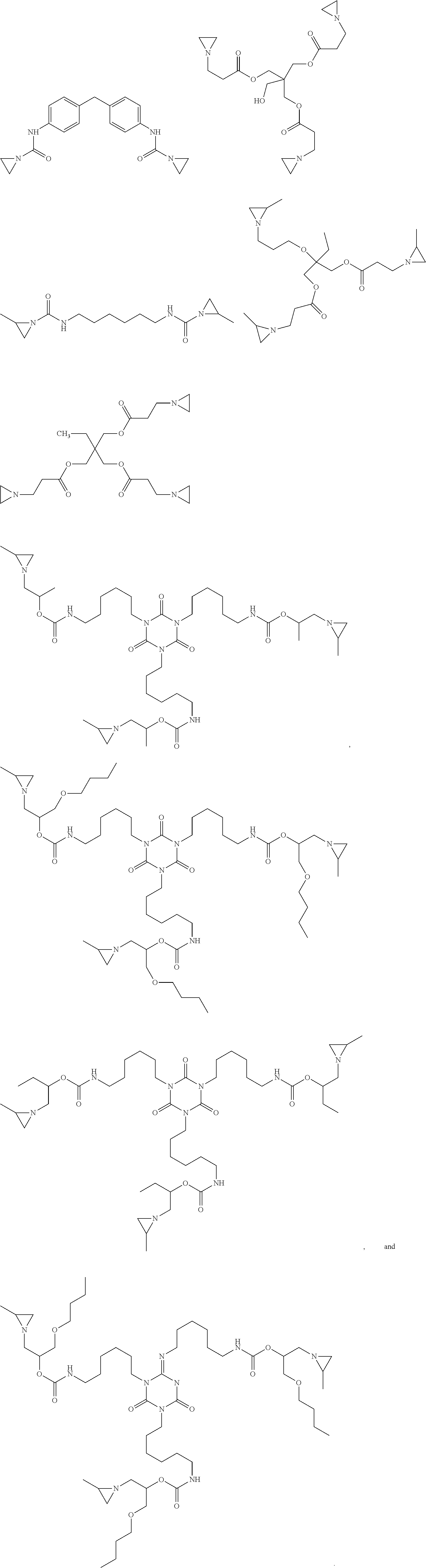

22. The stabilizer composition according to claim 18, wherein the hydrotalcite is a compound of the general formula
(M²⁺)₁₋ₓ·(M³⁺)ₓ·(OH)₂·(Aⁿ⁻)_{x/n}·m H₂O
wherein
the M of M²⁺ is one Mg, Ca, Sr, or Zn,
the M of M³⁺ is Al or B,
A is an anion with valency n,
n is 1 or 2,
0<x<0.5, and
m is a number from 0 to 20.

23. The stabilizer composition according to claim 22, wherein A is OH⁻, HCO³⁻, CH₃COO-, C₆H₅COO-, CO₃²⁻, SO₄²⁻, or HPO₄²⁻; or
the hydrotalcite is selected from the group consisting of Ca₄Al₂(OH)₁₂CO₃·5H₂O, Al₂O₃·6MgO·CO₂·12H₂O, Mg_{4,5}Al₂(OH)₁₃·CO₃·3.5H₂O, Mg₆Al₂(OH)₁₆·CO₃·4H₂O, 4MgO·AlO₃·CO₂·9H₂O, 4 MgO·Al₂O₃·CO₂·6H₂O, ZnO·3 MgO·Al₂O₃·CO₂·8-9H₂O and ZnO·3MgO·Al₂O₃·CO₂·5-6H₂O.

24. The stabilizer composition according to claim 18, wherein the dawsonite is a compound of the general formula
{(M₂O)ₘ·(Al₂O₃)·Zₒ·p H₂O}
wherein
M is an element selected from the group consisting of H, Li, Na, K, Mg_{1/2}, Ca_{1/2}, Sr_{1/2}, and Zn_{1/2};
Z is a substituent selected from the group consisting of CO₂, SO₂, (Cl₂O₇)_{1/2}, B₄O₆, S₂O₂ (thiosulphate) and C₂O₂ (oxalate);
if M is M_{1/2} or Ca_{1/2}, m is a number between 1 and 2, and in all other cases of M, m is a number between 1 and 3;
n a number between 1 and 4;
o a number between 2 and 4; and
p a number between 0 and 30.

25. The stabilizer composition according to claim 18, wherein the dawsonite is selected from the group consisting of potassium aluminocarbonate {(K₂₀)·(Al₂O₃)·(CO₂)₂·2H₂O}, sodium aluminothiosulphate {(Na₂₀)·(Al₂O₃)·(S₂O₂)₂·2H₂O}, potassium aluminosulphite {(K₂₀)·(Al₂O₃)·(SO₂)₂·2H₂O}, calcium aluminooxalate {(CaO)·(Al₂O₃)·(C₂O₂)₂·5H₂O}, magnesium aluminotetraborate {(MgO)·(Al₂O₃)·(B₄O₆)₂·5H₂O}, sodium aluminodihydroxycarbonate, potassium aluminodihydroxycarbonate, and naturally occurring alkali aluminocarbonate minerals.

26. The stabilizer composition according to claim 18, wherein the zeolite is a compound of the general formula M_{x/n}](AlO₂)ₓ(SiO₂)_{y}·w H2O
wherein
n is the charge of the cation M;
M is an element of the first or second main group,
y:x is a value from 0.8 to 15, and
w is a number from 0 to 300.

27. The stabilizer composition according to claim 26, wherein the zeolite is is selected from the group consisting of sodium aluminosilicates of the formulae Na₁₂Al₁₂Si₁₂O₄₈·27H₂O [Zeolith A], Na₆Al₆Si₅O₂₄·2NaX·7.5H₂O (X=OH, halogen, ClO₄ [sodalite]); Na₆Al₆Si₃₀O₇₂·24H₂O; Na₈Al₈Si₄₀O₉₅·24H₂O; Na₁₆Al₁₆Si₂₄O₈₀·16H₂O; Na₁₆Al₁₆Si₃₂O₉₆·16H₂O; Na₅₆Al₅₆Si₁₃₆O₃₈₄·250H₂O [zeolite Y], Na₈₆Al₈₆Si₁₀₆O₃₈₄·264H₂O [zeolite X]; and K₉Al₉Si₂₇O₇₂·22H₂O [zeolite L]; and zeolites in which the Na atoms of the aforementioned zeolites are partially or completely replaced by Li, K, Mg, Ca, Sr, or Zn atom or atoms.

28. The stabilizer composition according to claim 18, wherein the hydrotalcite, zeolite, dawsonite, or mixture thereof is anhydrous.

29. The stabilizer composition according to claim 18, wherein the weight ratio of the totality of the aziridine to the totality of the hydrotalcite, dawsonite and/or zeolite is from 20:1 to 1:20.

30. A method of stabilizing a condensation polymer against hydrolytic degradation comprising combining the condensation polymer with a stabilizer composition according to claim 18.

31. The method according to claim 30, wherein the stabilizer composition is combined in a weight ratio of from 0.01 to 10% by weight in relation to the polycondensation polymer.

32. The method according to claim 30, wherein the polycondensation polymer is selected from the group consisting of polyamides, polyesters of aliphatic or aromatic dicarboxylic acids and diols or of hydroxy-carboxylic acids, polycarbonates, polyester carbonates, and mixtures thereof.

33. The method according to claim 32, wherein
(a) the polyamides are selected from the group consisting of polyamide 6, polyamide 6.6, polyamide 6.9, polyamide 6.10, polyamide 4.6, polyamide 4.10, polyamide 6.12, polyamide 10.10, polyamide 10.12, polyamide 12.12, polyamide 4, polyamide 7, polyamide 8, polyamide 9, polyamide 11, polyamide 12, polyamide 6T, polyamide 9T, polyamide 6I, polyamide 6-3-T, blends of different polyamides, such as for example PA 6 and PA 6.6, PA 6T and PA 6I, PA 6.6 and PA 6T, or blends of polyamides and polyolefins,
(b) the polyesters are selected from the group consisting of polyethylene terephthalate (PET), polybutylene terephthalate (PBT), polytrimethylene terephthalate (PTT), polypropylene terephthalate (PPT), polyethylene naphthylate (PEN), poly-1,4-dimethylol cyclohexane terephthalate, polyhydroxybenzoate, polyhydroxynaphthalate, polylactic acid (PLA), polyhydroxybutyrate (PHB), polyhydroxyvalerate (PHV), polybutylene succinate (PBS), polybutylene succinate adipate (PBSA), polyethylene succinate, and polycaprolactone, and/or
c) polycarbonates, polyester carbonates, and blends selected from PC/ABS, PC/PBT, PC/PET/PBT, and PC/PA.

34. A hydrolysis-stabilized composition comprising at least one condensation polymer and a stabilizer composition according to 18.

35. The hydrolysis-stabilized composition according to claim 34, wherein the stabilizer composition is comprised in a weight ratio of from 0.01 to 10% by weight in relation to the polycondensation polymer.

36. The hydrolysis-stabilized composition according to claim 34, which further includes at least one additive selected from the group consisting of secondary antioxidants, UV absorbers, light stabilizers, metal deactivators, filler deactivators, antiozonants, nucleating agents, anti-nucleating agents, impact modifiers, plasticizers, lubricants, rheology modifiers, thixotropic agents, chain extenders, processing aids, demoulding aids, flame retardants, pigments, dyes, optical brighteners, antimicrobial agents, antistatic agents, slip agents, antiblocking agents, coupling agents, crosslinking agents, anti-crosslinking agents, hydrophilizing agents, hydrophobizing agents, hydrolysis stabilizers, adhesion promoters, dispersing agents, compatibilizers, oxygen scavengers, acid scavengers, blowing agents, degradation additives, defoaming agents, odour scavengers, marking agents, antifogging agents, fillers, and reinforcing agents.

37. The hydrolysis-stabilized composition according to claim 34, wherein the at least one condensation polymer is an aliphatic polyester.

38. A moulded part or moulded article produced from the hydrolysis-stabilized composition according to claim 34.

39. The moulded part or moulded article according claim 38, which is selected from the group consisting of a foil, a film, a foams, a fibre, a cable, a tube, a profile, a hollow body, a tape, a membrane, an adhesive, a part for the transport industry, a part for medical application, a part for household use, a part for an electrical appliance, a part of a vehicle, a consumer article, a packaging material, a furniture, and a textile.

40. The moulded part or moulded article according to claim 38, which is produced via extrusion, injection moulding, blow moulding, calendering, pressing processes, spinning processes, or rotomoulding.
